(19) United States
(12) Patent Application Publication
(10) Pub. No.: US 2026/0179816 A1
(43) Pub. Date: Jun. 25, 2026

(54) SOFT MAGNETIC POWDER, MAGNETIC CORE, MAGNETIC COMPONENT, AND ELECTRONIC DEVICE

(71) Applicant: TDK CORPORATION, Tokyo (JP)

(72) Inventors: Moe KIMURA, Tokyo (JP); Yoshiki KAJIURA, Tokyo (JP)

(73) Assignee: TDK CORPORATION, Tokyo (JP)

(21) Appl. No.: 19/432,589

(22) Filed: Dec. 24, 2025

(30) Foreign Application Priority Data
Dec. 24, 2024 (JP) 2024-227471
Oct. 9, 2025 (JP) 2025-171341

(51) Int. Cl. H01F 1/153; H01F 3/08; H01F 27/255

(52) U.S. Cl. CPC H01F 1/15308; H01F 1/15333; H01F 3/08; H01F 27/255

(57) ABSTRACT

A soft magnetic powder including soft magnetic metal particles having a particle size distribution, wherein when the soft magnetic metal particles are grouped into a first particle group, a second particle group, a third particle group, and a fourth particle group, and an average of number based cumulative frequencies of the first to fourth particle groups and average solidities of the first to fourth particle groups are plotted on a virtual two-dimensional coordinate to obtain a linear approximation of plotted datum using a least-squares method, a slope of the obtained approximated straight-line my satisfies an absolute value |my| of 0.005 or greater and 0.500 or less.

### TECHNICAL FIELD

The present disclosure relates to a soft magnetic powder, a magnetic core, a magnetic component, and an electronic device.

### BACKGROUND

Electronic components such as inductors, transformers, and choke coils are widely used for power circuits of various electronic devices. Such electronic components contain a coil and a magnetic core arranged inside the coil. In recent years, a soft magnetic powder including soft magnetic particles instead of conventionally used ferrite is widely used. Soft magnetic metals have higher saturation magnetization (saturated magnetization flux density) and better DC bias characteristic (larger DC superimposition bias current) than ferrite; thus, the soft magnetic metals are suited for downsizing an electronic component (magnetic core).

However, in the case that the soft magnetic metals are used for the magnetic core, eddy current readily occurs in the magnetic core due to conduction between the soft magnetic metal particles. That is, in the case that the soft magnetic metals are used for the magnetic core, core loss (eddy current loss) readily occurs. Due to the core loss, efficiency of the power circuit decreases, and the power consumption of the electronic device increases. Therefore, it is necessary to reduce core loss (see Patent Document 1).

Conventionally, by controlling a composition of a soft magnetic metal particle and a composition of an oxidized coating, core loss is reduced in general. However, once the composition of the soft magnetic metal particle is determined, permeability and DC bias characteristic are set; hence, degree of flexibility for designing is limited. Therefore, there is a demand for ways to reduce core loss other than using the composition of the soft magnetic metal particle.

### PRIOR ART DOCUMENT

### Patent Document

Patent Document 1: JP Patent Application Laid Open No. 2021-27327

### SUMMARY

The present disclosure is achieved in view of such circumstances, and the object is to provide a soft magnetic powder capable of improving core loss regardless of a composition of the soft magnetic metal particle.

In order to achieve the above-mentioned object, a soft magnetic powder according to one aspect of the present disclosure includes: soft magnetic metal particles having a particle size distribution, wherein among the soft magnetic alloy particles, particles having particle sizes satisfying a number-based cumulative frequency of greater than 30% and 40% or less are grouped as a first particle group, particles having particle sizes satisfying the number-based cumulative frequency of greater than 50% and 60% or less are grouped as a second particle group, particles having particle sizes satisfying the number-based cumulative frequency of greater than 70% and 80% or less are grouped as a third particle group, particles having particle sizes satisfying the number-based cumulative frequency of greater than 90% are grouped as a fourth particle group; and an absolute value of “my” satisfies |my| of 0.005 or greater and 0.500 or less, or preferably |my| may satisfy 0.010 or greater and 0.300 or less, provided that a virtual two-dimensional coordinate is set using the number-based cumulative frequency of the soft magnetic metal particles as a horizontal axis and a solidity of the soft magnetic metal particles as a vertical axis, an average of the number-based cumulative frequency obtained from each of the first particle group to the fourth particle group and an average of the solidity obtained from each of the first particle group to fourth particle group are plotted on the virtual two-dimensional coordinate, and linear approximation of plotted datum is obtained using a least-squares method to obtain a slope “my” of an obtained approximated straight line.

The present inventors have carried out keen study to attain the soft magnetic powder capable of improving the core loss regardless of the composition of the soft magnetic metal particle. As a result, the present inventors have found that the soft magnetic powder having the above-mentioned configuration is capable of improving the core less; thereby, the present disclosure was achieved.

Preferably, a median size in terms of volume of the soft magnetic metal particles may be 1 μm or larger and 50 μm or smaller; or, more preferably 2 μm or larger and 35 μm or smaller.

A magnetic core according to one aspect of the present disclosure includes the soft magnetic powder mentioned in above.

A magnetic component according to one aspect of the present disclosure includes the soft magnetic powder mentioned in above.

An electronic device according to one embodiment of the present disclosure includes the magnetic component mentioned in above.

### BRIEF DESCRIPTION DRAWINGS

FIG. 1 is a schematic sectional view of a coil component including a magnetic core according to an exemplary embodiment of the present disclosure.

FIG. 2 is a schematic sectional view of the magnetic core shown in FIG. 1.

FIG. 3 is a schematic view showing a calculation method of solidity of the magnetic metal particle.

FIG. 4 is a schematic cross-sectional view showing a device for manufacturing the soft magnetic powder according to the present embodiment.

FIG. 5A is a bottom view of the device viewing from the direction of arrow along a V-V line shown in FIG. 4.

FIG. 5B is a bottom view of the device according to a conventional example.

FIG. 6A is a graph showing a relation between a cumulative frequency and a solidity of the soft magnetic powder according to examples and comparative examples of the present disclosure.

### DETAILED DESCRIPTION

Hereinafter, an embodiment of the present disclosure will be described.

### First Embodiment

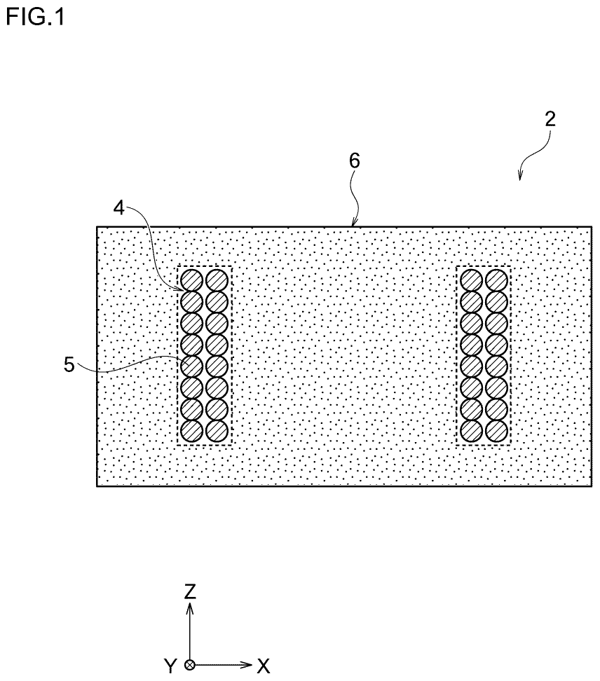

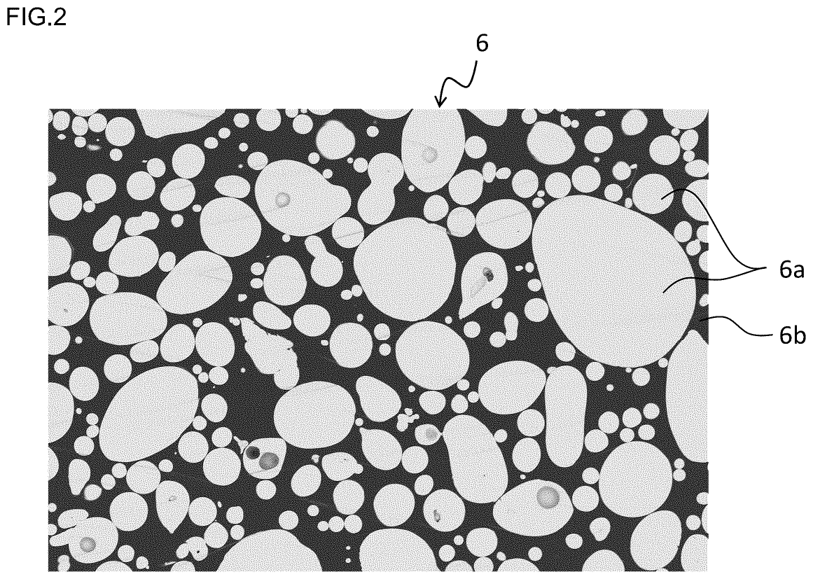

As shown in FIG. 1, a coil component 2 including a magnetic core 6 as one example of a magnetic component according to the present embodiment includes a wound wire part (coil) 4 configured of a conductor 5 in the magnetic core 6. FIG. 2 shows one example of an enlarged cross section of the magnetic core 6.

As shown in FIG. 2, the magnetic core 6 according to the present embodiment may include a resin 6b; and in the magnetic core 6, a soft magnetic powder including soft magnetic metal particles 6a is dispersed in the resin 6b. The soft magnetic powder according to the present embodiment may include a soft magnetic metal particle having a single pore or a plurality of pores.

An amount and a type of the resin 6b is not particularly limited, and examples of the resin 6b include thermosetting resins, such as a phenol resin and an epoxy resin. In the case that the magnetic core 6 includes a resin, preferably the amount of the resin 6b in the magnetic core 6 may be 1 mass % or more and 5 mass % or less with respect to a soft magnetic powder.

The soft magnetic metal particle 6a is preferably configured of a soft magnetic metal (including alloy) containing Fe or Co.

A soft magnetic metal according to the present embodiment may be configured of a soft magnetic powder having a compositional formula (Fe_{1-(α+β)}X1_{α}X2_{β})_{1-(a+b+c+d+e+f+g)}MₐB_{b}P_{c}Si_{d}CrₑC_{f}S_{g} (atomic ratio), wherein
X1 includes at least one selected from the group consisting of Co and Ni,
X2 includes at least one selected from the group consisting of Mn, Ag, Zn, As, Sn, Cu, Bi, N, O, rare earth elements, and platinum group elements,
M includes at least one selected from the group consisting of Nb, Hf, Zr, Ta, Mo, W, Al, Ti, and V,
α, β, a, b, c, d, e, f, and g of the compositional formula satisfy,

$$α \geq 0 ,$$

$$0 \leq β \leq 0.0 \; 30 ,$$

$$0 \leq a \leq 0.2 ,$$

$$0 \leq b \leq 0.2 \; 50 ,$$

$$0 \leq c \leq 0.2 ,$$

$$0 \leq d \leq 0.2 \; 00 ,$$

$$0 \leq e \leq 0.1 \; 30 ,$$

$$0 \leq f \leq 0.0 \; 70 ,$$

$$0 \leq g \leq 0.07 , and$$

$$0. 600 \leq 1 - ( a + b + c + d + e + f + g ) \leq 1. 0 .$$

Also, preferably α, β, a, b, c, d, e, f, and g of the compositional formula may satisfy

$$0 \leq α \leq 0.8 \; 00 ,$$

$$0 \leq β \leq 0.0 \; 30 ,$$

$$0 \leq a \leq 0.1 \; 40 ,$$

$$0. 02 \leq b \leq 0.2 ,$$

$$0 \leq c \leq 0.1 \; 00 ,$$

$$0 \leq d \leq 0.1 \; 30 ,$$

$$0 \leq e \leq 0.1 \; 10 ,$$

$$0 \leq f \leq 0.0 \; 50 ,$$

$$0 \leq g \leq 0.05 , and$$

$$0. 650 \leq 1 - ( a + b + c + d + e + f + g ) \leq 1. 0 .$$

When the soft magnetic metal particles included in the soft magnetic powder according to the present embodiment satisfy the above-mentioned composition range, the magnetic core including the soft magnetic powder according to the present embodiment can be expected to improve core loss.

As inevitable impurities, the soft magnetic particle may contain elements other than the above elements, i.e., the soft magnetic metal particles included in the soft magnetic powder according to the present embodiment may contain elements other than Fe, X1, X2, M, B, P, Si, Cr, C, and S. For example, the inevitable impurities may be included at 1 mass % or less with respect to 100 mass % of the soft magnetic metal (including alloy).

A median size in terms of volume of the soft magnetic metal particles included in the soft magnetic powder according to the present embodiment is not particularly limited, and preferably it may be 1 μm or larger and 50 μm or smaller, or more preferably 2 μm or larger and 35 μm or smaller in terms of an area circle equivalent diameter. Hereinafter, the area equivalent circular diameter may be simply referred to as the equivalent circle diameter. The area equivalent circle diameter may also be referred to as the Heywood diameter.

Although the soft magnetic metal particle included in the soft magnetic powder according to the present embodiment may have any microstructure, the soft magnetic metal particle preferably has an amorphous structure, a hetero-amorphous structure, or a nanocrystalline structure. This is because such structures readily improve the core loss of the magnetic core using the soft magnetic powder according to the present embodiment.

Note that, in the present embodiment, an amorphous structure refers to a structure in which an amorphous ratio X is 85% or greater and no crystals are observed. A hetero-amorphous structure refers to a structure in which an amorphous ratio X is 85% or greater and crystals are present in an amorphous solid.

A nanocrystalline structure refers to a structure having an amorphous ratio X of less than 85% and an average crystal size of 100 nm or less. A crystal structure refers to a structure having an amorphous ratio X of less than 85% and an average crystal size of larger than 100 nm.

When the soft magnetic powder according to the present embodiment has a hetero-amorphous structure, the average crystal size is preferably 0.1 nm or larger and 10 nm or smaller. When the soft magnetic powder according to the present embodiment has a nanocrystalline structure, the average crystal size is preferably 3 nm or larger and 50 nm or smaller.

Any method of evaluating the amorphous ratio X may be used. The amorphous ratio X may be measured using EBSD (electron backscattered diffraction) or electron diffraction. Also, the amorphous ratio X may be measured using XRD.

Hereinafter, a method for evaluating the amorphous ratio using XRD will be described. Any method for evaluating the average crystal size may be used, and a normal method, such as observation using TEM and a Scherrer method using XRD, can be appropriately used for evaluation.

When the amorphous ratio X is evaluated using XRD, the amorphous ratio X is calculated using (1) shown below.

$$X = 100 - ( Ic / ( Ic + Ia ) \times 100 ) \qquad ( 1 )$$

Ic: Crystal scattering integrated intensity
Ia: Amorphous scattering integrated intensity

An X-ray crystal structure analysis of the soft magnetic powder using XRD is performed for identifying phases, and peaks (Ic: crystal scattering integrated intensity, Ia: amorphous scattering integrated intensity) of crystallized Fe or a crystallized compound are read. From the intensities of these peaks, the crystallization ratio is determined, and the amorphous ratio X is calculated using the above (1).

In the present embodiment, as shown in FIG. 2, in the case that the cross section of the magnetic core 6 is cut to observe the cross section, the particle size of each particle 6a, a number-based cumulative frequency of the particle sizes, and the solidity of each particle 6a can be obtained. Any method may be used for calculating the particle size and the solidity.

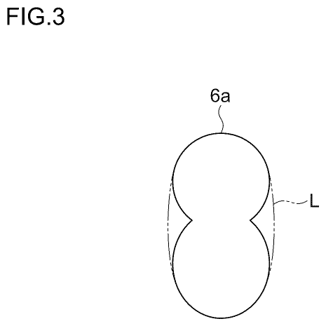

FIG. 3 is a figure used to explain a solidity. In order to calculate a solidity, for example, as shown in FIG. 3, first, a solidity circumference line L is estimated by drawing a line around the particle 6a, which contacts outer shell of the convex area of the particle 6a and does not contact the outer shell of the concave area of the particle 6a. In order to estimate the solidity circumference line L, Sklansky's algorithm, a gift-wrapping method, Graham scan, Quickhull method, etc., may be used. Next, for each particle 6a, an area S1 of the actual particle 6a and an internal area S2 of the solidity circumference line L corresponding to said particle 6a are obtained to calculate S1/S2. The calculated value of S1/S2 is deemed a solidity of each particle 6a. Also, the particle size of each particle 6a is obtained using an area circle equivalent diameter, as mentioned in above.

For example, an analysis program may be used to calculate the particle size and the solidity. However, when the analysis program or the like is used, portions that are not particles may be recognized as particles. In such case, said portions are disregarded from the calculation. Also, a particle which is cut at the end of the image is not included in the calculation for the particle size and the solidity, and at least 1000 particles 6a are preferably observed.

A particle image analyzer Morphologi G3 (Malvern Panalytical) may be used for the particle size and solidity calculation; and even in such case, the same tendencies are observed. Morphologi G3 is an analyzer that enables the powder to be dispersed using air to project individual particle shapes, and enables resulting projections to be evaluated.

In the present embodiment, among the soft magnetic metal particles 6a observed in FIG. 2 which is observed in the cross section, the particles having the particle sizes satisfying a number-based cumulative frequency of greater than 30% and 40% or less are grouped as a first particle group, greater than 50% and 60% or less are grouped as a second particle group, greater than 70% and 80% or less are grouped as a third particle group, and 90% or greater are grouped as a fourth particle group.

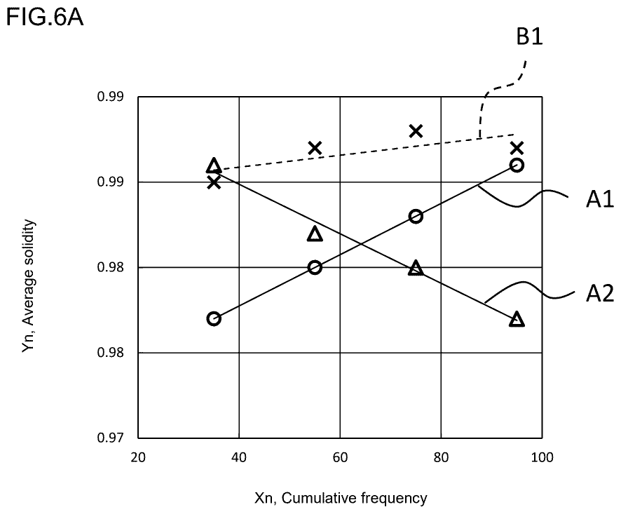

As shown in FIG. 6A, a virtual two-dimensional coordinate is set using the number-based cumulative frequency of the soft magnetic metal particles 6a on a horizontal axis and the solidity of the soft magnetic metal particles 6a on a vertical axis. Then, on the two-dimensional coordinate, an average number-based cumulative frequency of each of the first particle group to the fourth particle group and an average solidity of each of the first particle group to the fourth particle group are plotted.

The datum plotted as such is linear approximation obtained using a least-squares method. When a slope of the obtained approximated straight line is defined as “my”, in the present embodiment, as shown in the approximated straight line of A1 or A2 of FIG. 6A, an absolute value of slope “my” satisfies |my| of 0.005 or greater and 0.500 or less, or preferably 0.010 or greater and 0.300 or less. Note that, the soft magnetic metal particles of the conventional soft magnetic powder give the absolute value of slope “my” of the approximated straight line satisfying |my| of 0 or greater and 0.005 or less, as it is shown in the approximated straight line Bi of FIG. 6A.

The magnetic core having the soft magnetic powder containing the soft magnetic metal particles 6a of the present embodiment satisfying such relation can improve core loss regardless of the composition of the soft magnetic metal particles.

Hereinafter, a method for manufacturing the coil component 2 having the soft magnetic powder according to the present embodiment will be described.

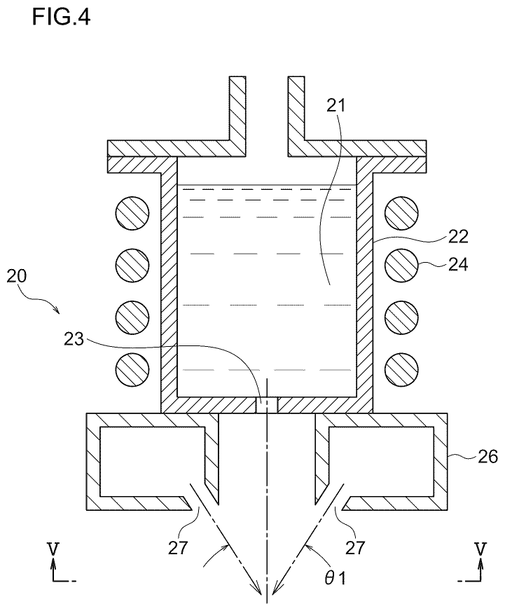

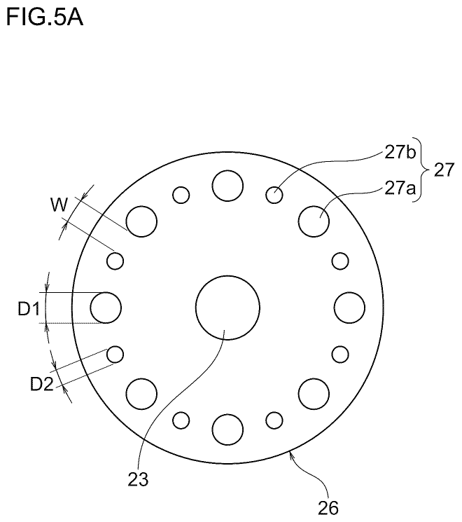

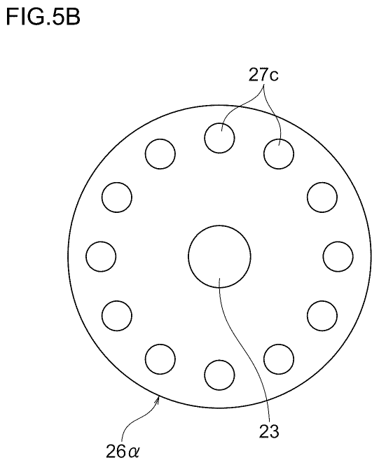

First, a method for manufacturing the soft magnetic powder according to the present embodiment will be described. For manufacturing the soft magnetic powder according to the present embodiment, any method may be used. The soft magnetic metal powder according to the present embodiment may be manufactured using methods such as a water atomization method, a gas atomization method, and a spray pyrolysis method. Also, the soft magnetic metal powder can be formed using a method which crushes a metal strip. Preferably, the soft magnetic powder is manufactured by a water atomization method or a gas atomization method using an atomization device 20 shown in FIG. 4 and FIG. 5A. By using the atomization device 20 to control a molten amount or water pressure (or gas pressure), the soft magnetic metal particles 6a of the present embodiment that the relation between the number-based cumulative frequency and the solidity are controlled can be readily obtained.

As shown in FIG. 4, the atomization device 20 includes a heat-resistant container 22 which contains the molten metal 21. A heating coil 24 is disposed around the outer circumference of the heat-resistant container 22, and the molten metal 21, placed in the container 22, is heated and maintained in a molten state. A molten metal discharge port 23 is provided at the bottom of the container 22, and the molten metal 21 is discharged as a molten metal drip 21a from the molten metal discharge port 23.

A spraying nozzle 26 is disposed at an outer portion of an outer bottom wall of the container 22 so as to surround the molten metal discharge port 23. The spraying nozzle 26 is provided with a gas spray port 27. From the gas spray port 27, a high-pressure water or a high-pressure gas is sprayed on the molten metal drip discharged from the molten metal discharge port 23.

As shown in FIG. 5A, in the present embodiment, a plurality of gas spray ports 27 disposed around the molten metal discharge port 23 includes a first gas spray port 27a and a second gas spray port 27b having smaller inner diameter D2 than a diameter D1 of the first spray port 27a. The first spray ports 27a and the second spray ports 27b are alternatingly disposed along the circumference direction while taking a predetermined space W between the two. Note that, the numbers and the positions of the first spray port 27a and the second spray port 27b are not particularly limited.

Also, D2/D1 is not particularly limited, as long as it is less than 1, and preferably D2/D1 is 4/5 to 1/3, 3/4 to 1/3, or 2/3 to 1/3. Further, the predetermined space W is not particularly limited, and for example it may be 1/2 or greater than the inner diameter D2 of the second spray port 27b and about 3 times or less of the inner diameter D1 of the first spray port 27a. Note that, as shown in FIG. 5B, a conventional spraying nozzle 26a has spray ports 27c having the same diameters and disposed along the circumference direction in predetermined intervals.

The high-pressure water or high-pressure gas is sprayed diagonally downwards in an angle of θ1 to the entire circumference of the molten metal discharged from the molten metal discharge port 23, and the molten metal drip turns into multiple molten droplets and moves along the flow of the high-pressure water or high-pressure gas, and to a cooling device or a collection device disposed at lower end in the gas or water flow direction.

In the present embodiment, the particle size of the soft magnetic metal particle 6a can be adjusted by appropriately changing atomizing conditions. The particle size can also be adjusted by dry classification, wet classification, etc. Examples of dry classification methods include dry sieving and air flow classification. Examples of wet classification methods include a classification using wet filtration classification and classification by centrifuging.

With a short time of contact with air, the molten metal 21 having the above composition easily oxidizes to form an oxide film. Once the oxide film is formed, it is difficult for the liquid drops to become finer. Using an inert gas or a reducing gas as a gas sprayed from the gas spray ports 27, formation of the oxide film can be prevented and also prevents from turning into powder. Examples of inert gases include nitrogen gas, argon gas, and helium gas. Examples of reducing gases include ammonia decomposition gas. A high-pressure water stream may be sprayed from the gas spray ports 27.

The soft magnetic powder including the soft magnetic metal particles 6a manufactured using the spraying nozzle 26 shown in FIG. 4 and FIG. 5A, for example, has a relation shown by an approximated straight line A1 or A2 of FIG. 6A; and the absolute value of slope “my” of the approximated straight line satisfies |my| of 0.005 or greater and 0.500 or less, or preferably 0.010 or greater and 0.300 or less. Also, the soft magnetic powder including the soft magnetic metal particles manufactured using the conventional spraying nozzle 26a shown in FIG. 5B, for example, has a relation shown by an approximated straight line B1 of FIG. 6A; and the absolute value of slope “my” of the approximated straight line is |my| of less than 0.005.

On the surface of the soft magnetic metal particle of the soft magnetic powder according to the present embodiment, a coating layer may be formed by the composition different from the soft magnetic metal particle, and the coating layer may be formed using a coating method. Even in the case that the coating layer is formed on the surface of the soft magnetic metal particle, in the present embodiment, the relation shown by the approximated straight line A1 or A2 shown in FIG. 6A is satisfied, and the absolute value of slope of “my” which is represented by |my| satisfies the above-mentioned relation. Alternatively, the coating layer may be formed on the surface so as to satisfy the above-mentioned relation.

The soft magnetic powder obtained as mentioned in above may be used as a molding powder to carry out molding; and thereby, a magnetic core can be obtained. Any method of molding may be used. As one example, a method for obtaining the magnetic core by press molding will be described.

First, the soft magnetic powder and the resin are mixed. Mixing the powder with the resin makes it easier to give a pressed body having high strength by molding. The resin may be any type of resin. Examples of the resin include a phenol resin and an epoxy resin. The amount of the resin is not limited. When the resin is added, 1 mass % or more and 5 mass % or less of the resin may be added to the magnetic powder. At this time, a soft magnetic metal powder and/or a non-magnetic powder besides the soft magnetic metal powder according to the present embodiment may be added. Also, modifiers, preservatives, dispersant, etc., may be added.

First, the soft magnetic powder and the resin are kneaded to give a resin compound. The resin compound may be a granulated powder. Any method of granulation may be used. For example, a stirrer may be used for granulation. The granulated powder may have any particle size.

The obtained resin compound is press molded to give a pressed body. The press molding pressure is not particularly limited. The resin included in the pressed body may be cured and can give the magnetic core. Any curing method may be used, and a heat treatment may be performed under conditions capable of curing of the resin.

In the present embodiment, as shown in FIG. 1, the coil which is formed by winding the conductor 5 is disposed inside the mold (not shown in the figure), and the soft magnetic powder obtained as mentioned in above is placed inside the mold as the molding powder, and then compress molded. Thereby, the coil component 2 can be obtained.

In the present embodiment, the molten amount and the water pressure or gas pressure are adjusted by using the atomization device 20 shown in FIG. 4 and FIG. 5A; thereby, distribution of the solidities in the soft magnetic powder can be controlled. Although the reason for this is not necessarily clear, the following is thought as the reason.

The water or gas sprayed from the first spray port 27a cuts the molten metal discharged from the molten metal discharge port 23 and turns into droplets. The water or gas sprayed from the second spray port 27b causes the droplets which are undergoing solidification to contact with each other or to change the shapes; thereby, the solidity can be controlled. The particle sizes of the powder which can be controlled differ depending on the water pressure or gas pressure, and the higher the water pressure or gas pressure, the smaller the particle size of the powder that can be reshaped. Thereby, the distribution of the solidity in the soft magnetic powder can be controlled. The particle size changes together with the change in the water pressure or gas pressure; thus, the molten amount is changed along with the water pressure or gas pressure to maintain the ratio between the molten amount and the water pressure to be constant. Thereby, the particle size is maintained constant.

The soft magnetic powder according to the present embodiment can readily improve the core loss.

The magnetic core according to the present embodiment may be used for any purpose. For example, the magnetic core can be suitably used as a magnetic core for an inductor, particularly a power inductor. Further, the magnetic core can be suitably used for an inductor which is made by integrally molding the magnetic core and a coil.

Further, the magnetic component including the above-mentioned magnetic powder may be suitably used for an electronic device such as a magnetic core, or it may be used for other electronic devices such as for a magnetic component other than the magnetic core. Examples of the magnetic component other than the magnetic core include a magnetic sheet.

In particular, because the above-mentioned magnetic core has improved core loss, the above-mentioned magnetic core is suitably used in fields in need of smaller size, higher frequency, higher efficiency, and energy saving. For example, the above-mentioned magnetic core can be suitably used as a magnetic core, a magnetic component, and an electronic device which are implemented in ICT equipment, electric vehicles, etc.

### Second Embodiment

The present embodiment is similar to the aforementioned embodiment except that a molding powder is prepared by adding other soft magnetic metal particles to the soft magnetic metal particles 6a according to the first embodiment, and the magnetic core is manufactured using the molding powder. The soft magnetic metal particle 6a according to the first embodiment may be mixed with said other soft magnetic metal particles. Said other soft magnetic metal particles are not limited, and the composition and the median size in terms of volume may be the same as or different from the soft magnetic metal particles 6a according to the first embodiment. Also, said other soft magnetic metal particles may be conventional soft magnetic metal particles which do not necessarily satisfy the relation shown by the approximated straight line A1 or A2 of FIG. 6A, but satisfy the relation of the approximated straight line B1.

Note that, the soft magnetic metal particles 6a satisfying the relation shown by the approximated straight line A1 or A2 of FIG. 6A preferably are 15 mass % or more, 25 mass % or more, 50 mass % or more, or 70 mass % or more with respect to the soft magnetic powder as a whole. In the cross section of the magnetic core, the soft magnetic metal particles 6a are preferably 3 area % or more with respect to the soft magnetic powder as a whole. The soft magnetic powder according to the present embodiment may be a powder which contains two or three peaks of particle size distribution.

In the present embodiment, the soft magnetic metal particles may have a single composition, or may include a plurality of compositions. The particles having the same composition are grouped as one particle group, and the soft magnetic metal particles of one or more particle groups may satisfy the relation shown by the approximated straight line A1 or A2 of FIG. 6A. Preferably, the soft magnetic metal particles of two or more particle groups preferably satisfy the relation shown by the approximated straight line A1 or A2 of FIG. 6A from the point of improvement in core loss.

The composition of the soft magnetic metal particle is not particularly limited. Examples include, pure iron such as carbonyl iron, Fe—Ni-based alloy, Fe—Si-based alloy, Fe—Si—Cr-based alloy, Fe—Si—Al-based alloy, Fe—Si—Al—Ni-based alloy, Fe—Ni—Si—Co-based alloy, Fe—Co-based alloy, Fe—Co—V-based alloy, Fe—Co—Si-based alloy, Fe—Co—Si—Al-based alloy, Fe—Si—B-based alloy, Fe—Si—B—C-based alloy, Fe—Si—B—C—Cr-based alloy, Fe—Nb—B-based alloy, Fe—Nb—B—P-based alloy, Fe—Nb—B—Si-based alloy, Fe—Co—P—C-based alloy, Fe—Co—B-based alloy, Fe—Co—B—Si-based alloy, Fe—Si—B—Nb—Cu-based alloy, Fe—Si—B—Nb—P-based alloy, Fe—Co—B—P—Si-based alloy, Fe—B—P—Si—Cu-based alloy, Fe—Co—B—P—Si—Cu-based alloy, and Fe—Co—B—P—Si—Cr-based alloy.

Note that, the composition of the metal magnetic particle can be analyzed using EDX or EPMA device attached to an electronic microscope. Also, 3DAP (three-dimensional atom probe) may be used for analyzing the composition of the metal magnetic particles. In the case of using 3DAP, a small area (for example, 20 nm×100 nm) can be set inside the target metal magnetic particle to measure the average composition, and the composition of the particle itself can be determined by removing the influence of the resin component included in the magnetic core or oxidation of the particle surface.

Note that, the present disclosure is not limited to the above-mentioned embodiments, and various modifications are possible within the scope of the present disclosure.

For example, the magnetic core of the present embodiment is not limited to a magnetic core including a wound wire part inside, and it may be a magnetic core which is formed by winding the conductor in a coil form.

### EXAMPLES

Below describes the present disclosure using examples; however, the present disclosure is not limited thereto.

### Experiment Example 1

Raw material metals were weighed and melted by high-frequency heating to produce a mother alloy having a composition of 57.4Fe-24.6Co-11.0B-5.0P-1.0Si-1.0Cr in atomic ratio.

The obtained mother alloy was heated to form a metal of a melted state. Then, in Example, a gas atomization device shown in FIG. 4 and FIG. 5A (in the tables, this is referred to as “mixed-velocity spraying method”) was used to produce a soft magnetic powder A of each sample under the conditions shown in Table 1A and Table 1B. A port size D1 of a first spray port 27a was 1.2 mm, a port size D2 of a second spray port 27b was 1/2 of the port size D1 of the first spray port 27a. Also, a space W was about 3/4 of the port size D1.

Also, in Comparative examples, a device shown in FIG. 4 and FIG. 5B (in the table, this is referred to as “conventional method”) using a gas atomization method was used to produce a soft magnetic powder B of each sample under the conditions shown in Table 1A and Table 1B. The gas atomization device used for Comparative examples is similar to the device shown in FIG. 5A except that, as shown in FIG. 5B, the gas atomization device used in Comparative examples had a port size of a spray port 27c which was the same as the port size D1 of the first spray port 27a shown in FIG. 5A, and the number of spray ports 27c was adjusted so that a total flow passage cross section area of the spray ports 27c and a total flow passage cross section area of the spray ports 27a and 27b as a whole were the same.

Next, a raw material powder of the metal magnetic particles and an epoxy resin were kneaded to give a resin compound. Specifically, the soft magnetic powder A produced using the above-mentioned method, a Fe powder as the soft magnetic metal powder B produced using the device shown in FIG. 4 and FIG. 5B of a conventional method, and the epoxy resin were mixed to give the resin compound. Note that, in all samples of Experiment example 1, an added amount (resin amount) of the epoxy resin in the resin compound was 2.6 parts by mass with respect to 100 parts by mass of the metal magnetic particles. Also, in all samples of Experiment example 1, the soft magnetic powder A and the soft magnetic powder B were blended so that a mass ratio of “soft magnetic powder A:soft magnetic powder B=70:30” was satisfied.

A mold was filled with the resin compound, and the resin compound was pressurized to give a toroidal pressed body. Pressure at this time was controlled so that permeability (i) of the magnetic core was 30. The pressed body was heated at 180° C. for 60 minutes for curing the epoxy resin included in the pressed body to give the toroidal shape magnetic core (outer diameter: 11 mm, inner diameter: 6.5 mm, and thickness: 2.5 mm).

In each sample of Experiment example 1, the obtained magnetic core was subject to below shown evaluations.

### Cross Section Observation of Magnetic Core

End surface polishing was carried out using ion milling, and the cross section of the magnetic core was observed using SEM so that at least 1000 particles were observed in a single field of view or a plurality of field of views. Conditions of SEM were accelerating voltage: 5 kV, spot intensity: 50, BSE image, and resolution: 2560×1920. Also, an automatic brightness-contrast function was used. Further, brightness/contrast was adjusted and the image was taken so that luminance (horizontal axis) of a luminance histogram of the image area spanned the entire area.

When performing image analysis, Otsu's method was used for image binarization. Otsu's method is a method which automatically determines a threshold where resolution is the largest in a luminance histogram. Also, in order to separate the particles contacting each other, Watershed algorithm was used to clarify the contacting interface, then the particles were separated for image processing. Watershed algorithm is a method to identify and separate the objects which are contacting each other.

From the cross-section image, Heywood diameter of the metal magnetic particle (an area circle equivalent diameter, a circle equivalent diameter) was measured, and also the composition of each metal magnetic particle was determined using surface analysis by EDX. Each metal magnetic particle observed in the cross section of the magnetic core was grouped into a powder A or a powder B. To calculate the particle size, a particle having at least an area per particle of 0.02 μm² or greater and a total pixel per particle of 300 px or greater was selected as a target. At least 1000 particles were observed as target particles. In each sample of Experiment example 1, a median size in terms of volume of the powder A was about 25 μm and a median size in terms of volume of the powder B was about 0.8 μm. Further, for each of the powder A and the powder B, a first particle group, a second particle group, a third particle group, and a fourth particle group were determined based on the obtained particle size distribution; then, data relating to a particle shape (solidity) was acquired. To calculate the solidity, Sklansky's algorithm was used.

Then, as shown in FIG. 6A, a virtual two-dimensional coordinate was set using the number-based cumulative frequency on a horizontal axis and the solidity on a vertical axis. Then, on the virtual two-dimensional coordinate, an average number-based cumulative frequency of each of the first particle group to the fourth particle group and an average solidity of each of the first particle group to the fourth particle group were plotted. A linear approximation of the plotted datum was obtained using a least-squares method, and a slope of the approximated straight line was obtained as “my”. An average solidity of the powder A was between 0.891 and 0.988, and an average circularity was between 0.945 and 0.968. Also, an average solidity of the powder B was between 0.971 and 0.975, and “my” was between −0.002 and 0.003. Results are shown in Table 1A and Table 1B. The slope “my” of the approximated straight line shows a rate of change of the solidity along with an increase of the particle size.

### Core Loss

Core loss (unit: kW/m³) of each magnetic core was measured using a BH analyzer (SY-8218 made by IWATSU ELECTRIC CO., LTD). Magnetic flux density when core loss was measured was set to 10 mT, and frequency was set to 3 MHz. Regarding Sample Nos. 1 to 12, the core loss of Sample No. 7 (Comparative example) was calculated, and a rate of decrease compared to the core loss of Comparative example (Sample No. 7) was deemed an improvement rate. Results are shown in Table 1A. Also, regarding Sample Nos. 13 to 24, the core loss of Sample No. 19 (Comparative example) was calculated, and a rate of decrease compared to the core loss of Comparative example (Sample No. 19) was deemed an improvement rate. Results are shown in Table 1B. In the present Experiment, the improvement rate of core loss of 7.5% or greater was deemed good, and 15% or greater was deemed particularly good.

TABLE 1A

| | | Conditions for | | | | | |
|---|---|---|---|---|---|---|---|
| | | manufacturing powder A | | | | | |
| | | | | | Gas | | |
| | | | | | pressure/ | | |
| | | | | | molten | | |
| | Example/ | | Gas | Molten | amount | Median size | |
| Sample | Comparative | | pressure | amount | (MPa · | (μm) | |
| No. | example | Atomizer | (MPa) | (kg/min) | min/kg) | Powder A | Powder B |
| 1 | Comparative | Conventional | 3.0 | 0.6 | 5.0 | 24.9 | 0.8 |
| | example | method | | | | | |
| 2 | Comparative | Mixed-velocity | 3.0 | 0.6 | 5.0 | 25.1 | 0.8 |
| | example | spraying | | | | | |
| | | method | | | | | |
| 3 | Example | Mixed-velocity | 3.5 | 0.7 | 5.0 | 24.8 | 0.8 |
| | | spraying | | | | | |
| | | method | | | | | |
| 4 | Example | Mixed-velocity | 4.0 | 0.8 | 5.0 | 24.9 | 0.8 |
| | | spraying | | | | | |
| | | method | | | | | |
| 5 | Example | Mixed-velocity | 4.5 | 0.9 | 5.0 | 25.1 | 0.8 |
| | | spraying | | | | | |
| | | method | | | | | |
| 6 | Example | Mixed-velocity | 5.0 | 1.0 | 5.0 | 24.9 | 0.8 |
| | | spraying | | | | | |
| | | method | | | | | |
| 7 | Comparative | Conventional | 5.0 | 1.0 | 5.0 | 24.9 | 0.8 |
| | example | method | | | | | |
| 8 | Example | Mixed-velocity | 5.5 | 1.1 | 5.0 | 25.2 | 0.8 |
| | | spraying | | | | | |
| | | method | | | | | |
| 9 | Example | Mixed-velocity | 6.0 | 1.2 | 5.0 | 25.0 | 0.8 |
| | | spraying | | | | | |
| | | method | | | | | |
| 10 | Example | Mixed-velocity | 6.5 | 1.3 | 5.0 | 25.1 | 0.8 |
| | | spraying | | | | | |
| | | method | | | | | |
| 11 | Comparative | Mixed-velocity | 7.0 | 1.4 | 5.0 | 24.8 | 0.8 |
| | example | spraying | | | | | |
| | | method | | | | | |
| 12 | Comparative | Conventional | 7.0 | 1.4 | 5.0 | 24.8 | 0.8 |
| | example | method | | | | | |

| | | | | Core loss | |
|---|---|---|---|---|---|
| | Core blending | | | Measured | Improved |
| Sample | ratio (wt %) | | Powder A | value | rate |
| No. | Powder A | Powder B | “my” | (kW/m3) | (%) |
| 1 | 70 | 30 | −0.003 | 1034 | 0.3 |
| 2 | 70 | 30 | −0.551 | 1035 | 0.2 |
| 3 | 70 | 30 | −0.500 | 956 | 7.8 |
| 4 | 70 | 30 | −0.350 | 905 | 12.7 |
| 5 | 70 | 30 | −0.295 | 862 | 16.9 |
| 6 | 70 | 30 | −0.101 | 861 | 17.0 |
| 7 | 70 | 30 | 0.003 | 1037 | — |
| 8 | 70 | 30 | −0.012 | 877 | 15.4 |
| 9 | 70 | 30 | −0.006 | 901 | 13.1 |
| 10 | 70 | 30 | −0.005 | 954 | 8.0 |
| 11 | 70 | 30 | −0.001 | 1034 | 0.3 |
| 12 | 70 | 30 | 0.003 | 1035 | 0.2 |

TABLE 1B

| | | Conditions for manufacturing powder A | | | | | |
|---|---|---|---|---|---|---|---|
| | | | | | Gas | | |
| | Example/ | | Gas | Molten | pressure/molten | Median size | |
| | Comparative | | pressure | amount | amount | (μm) | |
| Sample No. | example | Atomizer | (MPa) | (kg/min) | (MPa · min/kg) | Powder A | Powder B |
| 13 | Comparative | Conventional | 8.0 | 1.6 | 5.0 | 25.0 | 0.8 |
| | example | method | | | | | |
| 14 | Comparative | Mixed-velocity | 8.0 | 1.6 | 5.0 | 24.8 | 0.8 |
| | example | spraying | | | | | |
| | | method | | | | | |
| 15 | Example | Mixed-velocity | 8.5 | 1.7 | 5.0 | 25.0 | 0.8 |
| | | spraying | | | | | |
| | | method | | | | | |
| 16 | Example | Mixed-velocity | 9.0 | 1.8 | 5.0 | 25.0 | 0.8 |
| | | spraying | | | | | |
| | | method | | | | | |
| 17 | Example | Mixed-velocity | 9.5 | 1.9 | 5.0 | 24.9 | 0.8 |
| | | spraying | | | | | |
| | | method | | | | | |
| 18 | Example | Mixed-velocity | 10.0 | 2.0 | 5.0 | 25.0 | 0.8 |
| | | spraying | | | | | |
| | | method | | | | | |
| 19 | Comparative | Conventional | 10.0 | 2.0 | 5.0 | 24.9 | 0.8 |
| | example | method | | | | | |
| 20 | Example | Mixed-velocity | 10.5 | 2.1 | 5.0 | 24.8 | 0.8 |
| | | spraying | | | | | |
| | | method | | | | | |
| 21 | Example | Mixed-velocity | 11.0 | 2.2 | 5.0 | 25.0 | 0.8 |
| | | spraying | | | | | |
| | | method | | | | | |
| 22 | Example | Mixed-velocity | 11.5 | 2.3 | 5.0 | 25.0 | 0.8 |
| | | spraying | | | | | |
| | | method | | | | | |
| 23 | Comparative | Mixed-velocity | 12.0 | 2.4 | 5.0 | 25.1 | 0.8 |
| | example | spraying | | | | | |
| | | method | | | | | |
| 24 | Comparative | Conventional | 12.0 | 2.4 | 5.0 | 25.1 | 0.8 |
| | example | method | | | | | |

| | | | | Core loss | |
|---|---|---|---|---|---|
| | Core blending ratio | | | Measured | Improved |
| | (wt %) | | Powder A | value | rate |
| Sample No. | Powder A | Powder B | “my” | (kW/m3) | (%) |
| 13 | 70 | 30 | −0.003 | 1039 | 0.2 |
| 14 | 70 | 30 | 0.003 | 1041 | 0.1 |
| 15 | 70 | 30 | 0.005 | 957 | 8.2 |
| 16 | 70 | 30 | 0.006 | 903 | 13.3 |
| 17 | 70 | 30 | 0.010 | 866 | 16.9 |
| 18 | 70 | 30 | 0.103 | 869 | 16.6 |
| 19 | 70 | 30 | −0.002 | 1042 | — |
| 20 | 70 | 30 | 0.295 | 869 | 16.6 |
| 21 | 70 | 30 | 0.347 | 908 | 12.9 |
| 22 | 70 | 30 | 0.500 | 961 | 7.8 |
| 23 | 70 | 30 | 0.553 | 1041 | 0.1 |
| 24 | 70 | 30 | 0.001 | 1040 | 0.2 |

As shown in Table 1 A and Table 1B, by suitably controlling the solidity, the magnetic core of each Example including the soft magnetic powder A having the absolute value of the slope “my” of the solidity with respect to the cumulative frequency of the magnetic powder being 0.005 or greater and 0.5 or less had improved core loss compared to the magnetic core of Comparative example which the absolute value of “my” was less than 0.005. Also, when the absolute value of slope “my” of the solidity with respect to the cumulative frequency of the soft magnetic powder was 0.010 or greater and 0.300 or less, particularly improved core loss was confirmed.

### Experiment Example 2A

In Experiment example 2A, the soft magnetic powder A was produced similar to Sample Nos. 4, 6, 7, 18, and 21 of Experiment example 1 except that in Experiment example 2A, a water atomization method was used which sprayed water instead of inert gas from the gas spray port 27 shown in FIG. 5A or the gas spray port 27c shown in FIG. 5B; and also, water pressure was changed. Samples of the magnetic cores of Sample Nos. 25 to 54 were made by adjusting the molding pressure so that the permeabilities of the magnetic cores were 20, and the evaluations similar to Experiment example 1 were carried out. An average solidity of the soft magnetic powder A was between 0.919 and 0.975. Results are shown in Table 2A.

### Experiment Example 2B

In Experiment example 2B, the powder was made similar to Sample Nos. 4, 6, 7, 18, and 21 of Experiment example 1 except that the molten amount and the gas pressure were changed as shown in Table 2B in order to adjust the particle size. Samples of the magnetic cores according to Sample Nos. 55 to 59 were made by adjusting the molding pressure so that the permeabilities of the magnetic cores were 20, and samples of the magnetic cores according to Sample Nos. 60 to 79 were made by adjusting the molding pressure so that the permeabilities of the magnetic cores were 30. Then, the evaluations similar to Experiment example 1 were carried out. An average solidity of the soft magnetic powder A was between 0.916 and 0.976. Results are shown in Table 2B.

TABLE 2A

| | | Conditions for | | | | | | | |
|---|---|---|---|---|---|---|---|---|---|
| | | manufacturing powder A | | | | | | | |
| | | | | | Gas pressure/ | Powder A | | Core loss | |
| | Example/ | | Gas | Molten | molten | Median | | Measured | Improved |
| Sample | Comparative | | pressure | amount | amount | size | Powder A | value | rate |
| No. | example | Atomizer | (MPa) | (kg/min) | (MPa · min/kg) | (μm) | “my” | (kW/m3) | (%) |
| 25 | Example | Mixed-velocity | 50 | 3.4 | 14.5 | 0.8 | −0.353 | 84 | 9.7 |
| | | spraying method | | | | | | | |
| 26 | Example | Mixed-velocity | 60 | 4.1 | 14.5 | 0.8 | −0.105 | 82 | 11.8 |
| | | spraying method | | | | | | | |
| 27 | Comparative | Conventional method | 60 | 4.1 | 14.5 | 0.8 | 0.002 | 93 | — |
| | example | | | | | | | | |
| 28 | Example | Mixed-velocity | 80 | 5.5 | 14.5 | 0.8 | 0.106 | 82 | 11.8 |
| | | spraying method | | | | | | | |
| 29 | Example | Mixed-velocity | 100 | 6.9 | 14.5 | 0.8 | 0.352 | 84 | 9.7 |
| | | spraying method | | | | | | | |
| 30 | Example | Mixed-velocity | 50 | 3.6 | 14.0 | 1.0 | −0.353 | 91 | 10.8 |
| | | spraying method | | | | | | | |
| 31 | Example | Mixed-velocity | 60 | 4.3 | 14.0 | 1.0 | 0.101 | 88 | 13.7 |
| | | spraying method | | | | | | | |
| 32 | Comparative | Conventional method | 60 | 4.3 | 14.0 | 1.0 | −0.002 | 102 | — |
| | example | | | | | | | | |
| 33 | Example | Mixed-velocity | 80 | 5.7 | 14.0 | 1.0 | 0.104 | 87 | 14.7 |
| | | spraying method | | | | | | | |
| 34 | Example | Mixed-velocity | 100 | 7.1 | 14.0 | 1.0 | 0.351 | 91 | 10.8 |
| | | spraying method | | | | | | | |
| 35 | Example | Mixed-velocity | 50 | 3.7 | 13.5 | 2.0 | −0.353 | 100 | 13.0 |
| | | spraying method | | | | | | | |
| 36 | Example | Mixed-velocity | 60 | 4.4 | 13.5 | 2.0 | −0.103 | 96 | 16.5 |
| | | spraying method | | | | | | | |
| 37 | Comparative | Conventional method | 60 | 4.4 | 13.5 | 2.0 | 0.003 | 115 | — |
| | example | | | | | | | | |
| 38 | Example | Mixed-velocity | 80 | 5.9 | 13.5 | 2.0 | 0.109 | 96 | 16.5 |
| | | spraying method | | | | | | | |
| 39 | Example | Mixed-velocity | 100 | 7.4 | 13.5 | 2.0 | 0.352 | 100 | 12.9 |
| | | spraying method | | | | | | | |
| 40 | Example | Mixed-velocity | 50 | 3.8 | 13.0 | 3.1 | −0.351 | 115 | 12.9 |
| | | spraying method | | | | | | | |
| 41 | Example | Mixed-velocity | 60 | 4.6 | 13.0 | 3.0 | −0.109 | 110 | 16.7 |
| | | spraying method | | | | | | | |
| 42 | Comparative | Conventional method | 60 | 4.6 | 13.0 | 3.0 | −0.002 | 132 | — |
| | example | | | | | | | | |
| 43 | Example | Mixed-velocity | 80 | 6.2 | 13.0 | 3.1 | 0.101 | 110 | 16.7 |
| | | spraying method | | | | | | | |
| 44 | Example | Mixed-velocity | 100 | 7.7 | 13.0 | 3.0 | 0.353 | 116 | 12.1 |
| | | spraying method | | | | | | | |
| 45 | Example | Mixed-velocity | 50 | 4.0 | 12.5 | 5.1 | −0.349 | 156 | 13.3 |
| | | spraying method | | | | | | | |
| 46 | Example | Mixed-velocity | 60 | 4.8 | 12.5 | 5.0 | −0.102 | 149 | 17.2 |
| | | spraying method | | | | | | | |
| 47 | Comparative | Conventional method | 60 | 4.8 | 12.5 | 4.9 | 0.002 | 180 | — |
| | example | | | | | | | | |
| 48 | Example | Mixed-velocity | 80 | 6.4 | 12.5 | 5.0 | 0.106 | 149 | 17.2 |
| | | spraying method | | | | | | | |
| 49 | Example | Mixed-velocity | 100 | 8.0 | 12.5 | 5.0 | 0.354 | 157 | 12.8 |
| | | spraying method | | | | | | | |
| 50 | Example | Mixed-velocity | 50 | 4.2 | 12.0 | 10.1 | −0.346 | 297 | 12.7 |
| | | spraying method | | | | | | | |
| 51 | Example | Mixed-velocity | 60 | 5.0 | 12.0 | 10.2 | −0.108 | 286 | 15.9 |
| | | spraying method | | | | | | | |
| 52 | Comparative | Conventional method | 60 | 5.0 | 12.0 | 9.9 | 0.003 | 340 | — |
| | example | | | | | | | | |
| 53 | Example | Mixed-velocity | 80 | 6.7 | 12.0 | 10.0 | 0.105 | 281 | 17.4 |
| | | spraying method | | | | | | | |
| 54 | Example | Mixed-velocity | 100 | 8.3 | 12.0 | 9.8 | 0.347 | 298 | 12.4 |
| | | spraying method | | | | | | | |

TABLE 2B

| | | Conditions for manufacturing powder A | | | | Powder A | | Core loss | |
|---|---|---|---|---|---|---|---|---|---|
| | Example/ | | Gas | Molten | Gas pressure/ | Median | | Measured | Improved |
| Sample | Comparative | | pressure | amount | molten amount | size | Powder A | value | rate |
| No. | example | Atomizer | (MPa) | (kg/min) | (MPa · min/kg) | (μm) | “my” | (kW/m3) | (%) |
| 55 | Example | Mixed-velocity spraying method | 4.0 | 0.7 | 5.5 | 10.1 | −0.347 | 298 | 12.9 |
| 56 | Example | Mixed-velocity spraying method | 5.0 | 0.9 | 5.5 | 9.9 | −0.104 | 288 | 15.8 |
| 57 | Comparative | Conventional method | 5.0 | 0.9 | 5.5 | 10.2 | −0.003 | 342 | — |
| | example | | | | | | | | |
| 58 | Example | Mixed-velocity spraying method | 10.0 | 1.8 | 5.5 | 10.0 | −0.109 | 287 | 16.1 |
| 59 | Example | Mixed-velocity spraying method | 10.5 | 1.9 | 5.5 | 9.9 | 0.353 | 295 | 13.7 |
| 4 | Example | Mixed-velocity spraying method | 4.0 | 0.8 | 5.0 | 24.9 | −0.350 | 905 | 12.7 |
| 6 | Example | Mixed-velocity spraying method | 5.0 | 1.0 | 5.0 | 24.9 | −0.101 | 861 | 17.0 |
| 7 | Comparative | Conventional method | 5.0 | 1.0 | 5.0 | 24.9 | 0.003 | 1037 | — |
| | example | | | | | | | | |
| 18 | Example | Mixed-velocity spraying method | 10.0 | 2.0 | 5.0 | 25.0 | 0.103 | 869 | 16.2 |
| 21 | Example | Mixed-velocity spraying method | 10.5 | 2.1 | 5.0 | 25.0 | 0.347 | 908 | 12.4 |
| 60 | Example | Mixed-velocity spraying method | 4.0 | 0.9 | 4.5 | 35.1 | −0.349 | 1373 | 12.1 |
| 61 | Example | Mixed-velocity spraying method | 5.0 | 1.1 | 4.5 | 35.0 | −0.108 | 1303 | 16.6 |
| 62 | Comparative | Conventional method | 5.0 | 1.1 | 4.5 | 34.9 | −0.001 | 1562 | — |
| | example | | | | | | | | |
| 63 | Example | Mixed-velocity spraying method | 10.0 | 2.2 | 4.5 | 35.0 | 0.105 | 1298 | 16.9 |
| 64 | Example | Mixed-velocity spraying method | 10.5 | 2.3 | 4.5 | 34.9 | 0.353 | 1350 | 13.6 |
| 65 | Example | Mixed-velocity spraying method | 4.0 | 1.0 | 4.0 | 40.1 | −0.346 | 1878 | 11.2 |
| 66 | Example | Mixed-velocity spraying method | 5.0 | 1.3 | 4.0 | 40.0 | −0.109 | 1802 | 14.8 |
| 67 | Comparative | Conventional method | 5.0 | 1.3 | 4.0 | 40.1 | −0.002 | 2115 | — |
| | example | | | | | | | | |
| 68 | Example | Mixed-velocity spraying method | 10.0 | 2.5 | 4.0 | 40.0 | 0.105 | 1806 | 14.6 |
| 69 | Example | Mixed-velocity spraying method | 10.5 | 2.6 | 4.0 | 39.9 | 0.347 | 1884 | 10.9 |
| 70 | Example | Mixed-velocity spraying method | 4.0 | 1.1 | 3.5 | 50.0 | −0.354 | 2884 | 10.4 |
| 71 | Example | Mixed-velocity spraying method | 5.0 | 1.4 | 3.5 | 49.8 | −0.108 | 2778 | 13.7 |
| 72 | Comparative | Conventional method | 5.0 | 1.4 | 3.5 | 50.0 | 0.003 | 3219 | — |
| | example | | | | | | | | |
| 73 | Example | Mixed-velocity spraying method | 10.0 | 2.9 | 3.5 | 49.9 | 0.104 | 2762 | 14.2 |
| 74 | Example | Mixed-velocity spraying method | 10.5 | 3.0 | 3.5 | 49.9 | 0.353 | 2878 | 10.6 |
| 75 | Example | Mixed-velocity spraying method | 4.0 | 1.3 | 3.0 | 55.3 | −0.35 | 3595 | 7.6 |
| 76 | Example | Mixed-velocity spraying method | 5.0 | 1.7 | 3.0 | 55.1 | −0.105 | 3490 | 10.3 |
| 77 | Comparative | Conventional method | 5.0 | 1.7 | 3.0 | 54.8 | −0.002 | 3891 | — |
| | example | | | | | | | | |
| 78 | Example | Mixed-velocity spraying method | 10.0 | 3.3 | 3.0 | 55.2 | 0.103 | 3498 | 10.1 |
| 79 | Example | Mixed-velocity spraying method | 10.5 | 3.5 | 3.0 | 54.9 | 0.348 | 3591 | 7.7 |

As shown in Table 2A and Table 2B, even in the case that the particle size of the powder A was changed, the magnetic core of each Example including the soft magnetic powder A with the suitably adjusted solidity was able to improve core loss compared to the magnetic core of Comparative examples. As Sample Nos. 50 to 59 having the median size of about 10 μm in terms of volume indicate, whether the magnetic core was produced using a water atomization method or a gas atomization method, the magnetic core of each Example including the soft magnetic powder A with the suitably adjusted solidity was able to improve core loss compared to the magnetic core of Comparative examples.

### Experiment Example 3

In Experiment example 3, the soft magnetic powder A was made similar to Sample Nos. 4, 6, 7, 18, and 21 except that the compositions were changed as shown in Tables 3A to 3F; and samples of the magnetic cores of Sample Nos. 80 to 349 were formed. The evaluations similar to Experiment example 1 were carried out. An average solidity of the soft magnetic powder A was between 0.924 and 0.973. Results are shown in Tables 3A to 3F.

TABLE 3A

| | | | | | | | | | Core loss | |
|---|---|---|---|---|---|---|---|---|---|---|
| | Example/ | | | | | Gas pressure/ | Powder A | | Measured | Improved |
| | Comparative | Powder A composition | | Gas pressure | Molten amount | molten amount | Median size | Powder A | value | rate |
| Sample No. | example | (at %) | Atomizer | (MPa) | (kg/min) | (MPa · min/kg) | (μm) | “my” | (kW/m3) | (%) |
| 4 | Example | 57.4Fe—24.6Co—11.0B—5.0P—1.0Si—1.0Cr | Mixed-velocity spraying method | 4.0 | 0.8 | 5.0 | 24.9 | −0.350 | 905 | 12.7 |
| 6 | Example | | Mixed-velocity spraying method | 5.0 | 1.0 | 5.0 | 24.9 | −0.101 | 861 | 17.0 |
| 7 | Comparative | | Conventional method | 5.0 | 1.0 | 5.0 | 24.9 | 0.003 | 1037 | — |
| | example | | | | | | | | | |
| 18 | Example | | Mixed-velocity spraying method | 10.0 | 2.0 | 5.0 | 25 | 0.103 | 869 | 16.2 |
| 21 | Example | | Mixed-velocity spraying method | 10.5 | 2.1 | 5.0 | 25 | 0.347 | 908 | 12.4 |
| 80 | Example | 68.8Fe—17.2Co—9.5B—4.0P—0.5Si | Mixed-velocity spraying method | 4.0 | 0.8 | 5.0 | 25.0 | −0.354 | 889 | 13.8 |
| 81 | Example | | Mixed-velocity spraying method | 5.0 | 1.0 | 5.0 | 25.1 | −0.105 | 864 | 16.2 |
| 82 | Comparative | | Conventional method | 5.0 | 1.0 | 5.0 | 25.0 | −0.002 | 1031 | — |
| | example | | | | | | | | | |
| 83 | Example | | Mixed-velocity spraying method | 10.0 | 2.0 | 5.0 | 24.9 | 0.107 | 856 | 17.0 |
| 84 | Example | | Mixed-velocity spraying method | 10.5 | 2.1 | 5.0 | 24.8 | 0.348 | 893 | 13.4 |
| 85 | Example | 56.7Fe—24.3Co—11.0B—2.0P—6.0Si | Mixed-velocity spraying method | 4.0 | 0.8 | 5.0 | 25.2 | −0.349 | 1058 | 12.6 |
| 86 | Example | | Mixed-velocity spraying method | 5.0 | 1.0 | 5.0 | 24.9 | −0.106 | 1016 | 16.0 |
| 87 | Comparative | | Conventional method | 5.0 | 1.0 | 5.0 | 24.8 | −0.001 | 1210 | — |
| | example | | | | | | | | | |
| 88 | Example | | Mixed-velocity spraying method | 10.0 | 2.0 | 5.0 | 25.0 | 0.109 | 1009 | 16.6 |
| 89 | Example | | Mixed-velocity spraying method | 10.5 | 2.1 | 5.0 | 24.9 | 0.349 | 1055 | 12.8 |
| 90 | Example | 56.7Fe—24.3Co—11.0B—4.0P—4.0Si | Mixed-velocity spraying method | 4.0 | 0.8 | 5.0 | 25.1 | −0.352 | 1040 | 12.6 |
| 91 | Example | | Mixed-velocity spraying method | 5.0 | 1.0 | 5.0 | 24.9 | −0.104 | 988 | 17.0 |
| 92 | example | | Conventional method | 5.0 | 1.0 | 5.0 | 24.8 | 0.001 | 1190 | — |
| 93 | Example | | Mixed-velocity spraying method | 10.0 | 2.0 | 5.0 | 25.0 | 0.104 | 1000 | 16.0 |
| 94 | Example | | Mixed-velocity spraying method | 10.5 | 2.1 | 5.0 | 24.8 | 0.350 | 1041 | 12.5 |
| 95 | Example | 56.7Fe—24.3Co—11.0B—6.0P—2.0Si | Mixed-velocity spraying method | 4.0 | 0.8 | 5.0 | 25.0 | −0.354 | 1079 | 12.5 |
| 96 | Example | | Mixed-velocity spraying method | 5.0 | 1.0 | 5.0 | 24.8 | −0.102 | 1025 | 16.9 |
| 97 | example | | Conventional method | 5.0 | 1.0 | 5.0 | 25.0 | −0.001 | 1233 | — |
| 98 | Example | | Mixed-velocity spraying method | 10.0 | 2.0 | 5.0 | 24.8 | 0.102 | 1032 | 16.3 |
| 99 | Example | | Mixed-velocity spraying method | 10.5 | 2.1 | 5.0 | 25.1 | 0.347 | 1081 | 12.3 |
| 100 | Example | 56.7Fe—24.3Co—10.0B—1.0P—8.0Si | Mixed-velocity spraying method | 4.0 | 0.8 | 5.0 | 25.0 | −0.349 | 1103 | 12.4 |
| 101 | Example | | Mixed-velocity spraying method | 5.0 | 1.0 | 5.0 | 24.9 | −0.103 | 1045 | 17.0 |
| 102 | Comparative | | Conventional method | 5.0 | 1.0 | 5.0 | 25.0 | −0.003 | 1259 | — |
| | example | | | | | | | | | |
| 103 | Example | | Mixed-velocity spraying method | 10.0 | 2.0 | 5.0 | 25.0 | 0.106 | 1051 | 16.5 |
| 104 | Example | | Mixed-velocity spraying method | 10.5 | 2.1 | 5.0 | 24.9 | 0.349 | 1103 | 12.4 |
| 105 | Example | 56.7Fe—24.3Co—10.0B—3.0P—6.0Si | Mixed-velocity spraying method | 4.0 | 0.8 | 5.0 | 25.0 | −0.348 | 1038 | 12.7 |
| 106 | Example | | Mixed-velocity spraying method | 5.0 | 1.0 | 5.0 | 24.8 | −0.108 | 995 | 16.3 |
| 107 | Comparative | | Conventional method | 5.0 | 1.0 | 5.0 | 25.0 | 0.002 | 1189 | — |
| | example | | | | | | | | | |
| 108 | Example | | Mixed-velocity spraying method | 10.0 | 2.0 | 5.0 | 24.8 | 0.103 | 994 | 16.4 |
| 109 | Example | | Mixed-velocity spraying method | 10.5 | 2.1 | 5.0 | 25.1 | 0.352 | 1039 | 12.6 |
| 110 | Example | 56.7Fe—24.3Co—10.0B—5.0P—4.0Si | Mixed-velocity spraying method | 4.0 | 0.8 | 5.0 | 25.0 | −0.347 | 926 | 12.5 |
| 111 | Example | | Mixed-velocity spraying method | 5.0 | 1.0 | 5.0 | 24.9 | −0.107 | 877 | 17.1 |
| 112 | Comparative | | Conventional method | 5.0 | 1.0 | 5.0 | 25.0 | −0.003 | 1058 | — |
| | example | | | | | | | | | |
| 113 | Example | | Mixed-velocity spraying method | 10.0 | 2.0 | 5.0 | 25.0 | 0.102 | 882 | 16.6 |
| 114 | Example | | Mixed-velocity spraying method | 10.5 | 2.1 | 5.0 | 24.9 | 0.346 | 925 | 12.6 |
| 115 | Example | 63.0Fe—21.0Co—10.5B—4.0P—0.5Si—1.0C | Mixed-velocity spraying method | 4.0 | 0.8 | 5.0 | 25.0 | −0.353 | 899 | 13.5 |
| 116 | Example | | Mixed-velocity spraying method | 5.0 | 1.0 | 5.0 | 24.9 | −0.107 | 870 | 16.3 |
| 117 | Comparative | | Conventional method | 5.0 | 1.0 | 5.0 | 25.0 | 0.003 | 1039 | — |
| | example | | | | | | | | | |
| 118 | Example | | Mixed-velocity spraying method | 10.0 | 2.0 | 5.0 | 24.9 | 0.102 | 868 | 16.5 |
| 119 | Example | | Mixed-velocity spraying method | 10.5 | 2.1 | 5.0 | 24.8 | 0.346 | 907 | 12.7 |
| 120 | Example | 57.4Fe—24.6Co—11.0B—4.0P—1.0Si—1.0C—1.0Cr | Mixed-velocity spraying method | 4.0 | 0.8 | 5.0 | 25.2 | −0.351 | 885 | 13.4 |
| 121 | Example | | Mixed-velocity spraying method | 5.0 | 1.0 | 5.0 | 25.2 | −0.101 | 856 | 16.2 |
| 122 | Comparative | | Conventional method | 5.0 | 1.0 | 5.0 | 25.2 | 0.001 | 1022 | — |
| | example | | | | | | | | | |
| 123 | Example | | Mixed-velocity spraying method | 10.0 | 2.0 | 5.0 | 25.0 | 0.105 | 847 | 17.1 |
| 124 | Example | | Mixed-velocity spraying method | 10.5 | 2.1 | 5.0 | 25.0 | 0.349 | 897 | 12.2 |

TABLE 3B

| | | | | | | | | | Core loss | |
|---|---|---|---|---|---|---|---|---|---|---|
| | Example/ | | | | | Gas pressure/ | Powder A | | Measured | Improved |
| | Comparative | Powder A composition | | Gas pressure | Molten amount | molten amount | Median size | Powder A | value | rate |
| Sample No. | example | (at %) | Atomizer | (MPa) | (kg/min) | (MPa · min/kg) | (μm) | “my” | (kW/m3) | (%) |
| 125 | Example | 56.0Fe—24.0Co—10.0B—3.0P—6.0Si—1.0C | Mixed-velocity spraying method | 4.0 | 0.8 | 5.0 | 25.2 | −0.352 | 955 | 12.3 |
| 126 | Example | | Mixed-velocity spraying method | 5.0 | 1.0 | 5.0 | 24.9 | −0.107 | 904 | 17.0 |
| 127 | Comparative | | Conventional method | 5.0 | 1.0 | 5.0 | 24.8 | −0.001 | 1089 | — |
| | example | | | | | | | | | |
| 128 | Example | | Mixed-velocity spraying method | 10.0 | 2.0 | 5.0 | 25.0 | 0.107 | 903 | 17.1 |
| 129 | Example | | Mixed-velocity spraying method | 10.5 | 2.1 | 5.0 | 24.9 | 0.351 | 951 | 12.7 |
| 130 | Example | 56.0Fe—24.0Co—10.0B—5.0P—4.0Si—1.0C | Mixed-velocity spraying method | 4.0 | 0.8 | 5.0 | 25.1 | −0.351 | 961 | 12.6 |
| 131 | Example | | Mixed-velocity spraying method | 5.0 | 1.0 | 5.0 | 24.9 | −0.103 | 922 | 16.1 |
| 132 | Comparative | | Conventional method | 5.0 | 1.0 | 5.0 | 24.8 | −0.001 | 1099 | — |
| | example | | | | | | | | | |
| 133 | Example | | Mixed-velocity spraying method | 10.0 | 2.0 | 5.0 | 25.0 | 0.101 | 915 | 16.7 |
| 134 | Example | | Mixed-velocity spraying method | 10.5 | 2.1 | 5.0 | 24.8 | 0.352 | 962 | 12.5 |
| 135 | Example | 56.0Fe—24.0Co—10.0B—7.0P—2.0Si—1.0C | Mixed-velocity spraying method | 4.0 | 0.8 | 5.0 | 25.0 | −0.353 | 963 | 12.7 |
| 136 | Example | | Mixed-velocity spraying method | 5.0 | 1.0 | 5.0 | 25.1 | −0.102 | 922 | 16.4 |
| 137 | Comparative | | Conventional method | 5.0 | 1.0 | 5.0 | 25.2 | 0.001 | 1103 | — |
| | example | | | | | | | | | |
| 138 | Example | | Mixed-velocity spraying method | 10.0 | 2.0 | 5.0 | 25.2 | 0.104 | 924 | 16.2 |
| 139 | Example | | Mixed-velocity spraying method | 10.5 | 2.1 | 5.0 | 25.0 | 0.350 | 965 | 12.5 |
| 140 | Example | 68.0Fe—17.0Co—12.0B—2.0P—1.0Si | Mixed-velocity spraying method | 4.0 | 0.8 | 5.0 | 24.9 | −0.346 | 945 | 12.3 |
| 141 | Example | | Mixed-velocity spraying method | 5.0 | 1.0 | 5.0 | 25.1 | −0.101 | 896 | 16.9 |
| 142 | Comparative | | Conventional method | 5.0 | 1.0 | 5.0 | 25.2 | −0.003 | 1078 | — |
| | example | | | | | | | | | |
| 143 | Example | | Mixed-velocity spraying method | 10.0 | 2.0 | 5.0 | 25.0 | 0.108 | 904 | 16.1 |
| 144 | Example | | Mixed-velocity spraying method | 10.5 | 2.1 | 5.0 | 25.1 | 0.353 | 944 | 12.4 |
| 145 | Example | 66.4Fe—16.6Co—14.0B—2.0P—1.0Si | Mixed-velocity spraying method | 4.0 | 0.8 | 5.0 | 25.0 | −0.351 | 944 | 12.6 |
| 146 | Example | | Mixed-velocity spraying method | 5.0 | 1.0 | 5.0 | 25.2 | −0.105 | 901 | 16.6 |
| 147 | Comparative | | Conventional method | 5.0 | 1.0 | 5.0 | 25.1 | 0.002 | 1080 | — |
| | example | | | | | | | | | |
| 148 | Example | | Mixed-velocity spraying method | 10.0 | 2.0 | 5.0 | 24.9 | 0.104 | 901 | 16.6 |
| 149 | Example | | Mixed-velocity spraying method | 10.5 | 2.1 | 5.0 | 24.9 | 0.351 | 944 | 12.6 |
| 150 | Example | 64.8Fe—16.2Co—16.0B—2.0P—1.0Si | Mixed-velocity spraying method | 4.0 | 0.8 | 5.0 | 25.1 | −0.348 | 964 | 12.4 |
| 151 | Example | | Mixed-velocity spraying method | 5.0 | 1.0 | 5.0 | 24.9 | −0.107 | 914 | 16.9 |
| 152 | Comparative | | Conventional method | 5.0 | 1.0 | 5.0 | 25.1 | −0.001 | 1100 | — |
| | example | | | | | | | | | |
| 153 | Example | | Mixed-velocity spraying method | 10.0 | 2.0 | 5.0 | 25.2 | 0.104 | 921 | 16.3 |
| 154 | Example | | Mixed-velocity spraying method | 10.5 | 2.1 | 5.0 | 24.8 | 0.347 | 965 | 12.3 |
| 155 | Example | 63.2Fe—15.8Co—18.0B—2.0P—1.0Si | Mixed-velocity spraying method | 4.0 | 0.8 | 5.0 | 25.1 | −0.351 | 872 | 12.7 |
| 156 | Example | | Mixed-velocity spraying method | 5.0 | 1.0 | 5.0 | 25.1 | −0.109 | 838 | 16.1 |
| 157 | Comparative | | Conventional method | 5.0 | 1.0 | 5.0 | 24.9 | 0.000 | 999 | — |
| | example | | | | | | | | | |
| 158 | Example | | Mixed-velocity spraying method | 10.0 | 2.0 | 5.0 | 24.8 | 0.104 | 829 | 17.0 |
| 159 | Example | | Mixed-velocity spraying method | 10.5 | 2.1 | 5.0 | 24.9 | 0.346 | 873 | 12.6 |
| 160 | Example | 61.6Fe—15.4Co—20.0B—2.0P—1.0Si | Mixed-velocity spraying method | 4.0 | 0.8 | 5.0 | 25.2 | −0.354 | 921 | 12.8 |
| 161 | Example | | Mixed-velocity spraying method | 5.0 | 1.0 | 5.0 | 24.9 | −0.101 | 876 | 17.0 |
| 162 | Comparative | | Conventional method | 5.0 | 1.0 | 5.0 | 25.0 | 0.000 | 1056 | — |
| | example | | | | | | | | | |
| 163 | Example | | Mixed-velocity spraying method | 10.0 | 2.0 | 5.0 | 24.9 | 0.101 | 887 | 16.0 |
| 164 | Example | | Mixed-velocity spraying method | 10.5 | 2.1 | 5.0 | 24.9 | 0.346 | 921 | 12.8 |
| 165 | Example | 62.2Fe—20.8Co—15.5B—1.0P—0.5Si | Mixed-velocity spraying method | 4.0 | 0.8 | 5.0 | 24.9 | −0.354 | 867 | 12.3 |
| 166 | Example | | Mixed-velocity spraying method | 5.0 | 1.0 | 5.0 | 25.1 | −0.107 | 821 | 17.0 |
| 167 | Comparative | | Conventional method | 5.0 | 1.0 | 5.0 | 24.9 | −0.002 | 989 | — |
| | example | | | | | | | | | |
| 168 | Example | | Mixed-velocity spraying method | 10.0 | 2.0 | 5.0 | 25.0 | 0.109 | 831 | 16.0 |
| 169 | Example | | Mixed-velocity spraying method | 10.5 | 2.1 | 5.0 | 25.0 | 0.346 | 866 | 12.4 |

TABLE 3C

| | | | | | | | | | Core loss | |
|---|---|---|---|---|---|---|---|---|---|---|
| | Example/ | | | | | Gas pressure/ | Powder A | | Measured | Improved |
| | Comparative | Powder A composition | | Gas pressure | Molten amount | molten amount | Median size | Powder A | value | rate |
| Sample No. | example | (at %) | Atomizer | (MPa) | (kg/min) | (MPa · min/kg) | (μm) | “my” | (kW/m3) | (%) |
| 170 | Example | 62.2Fe—20.8Co—13.5B—3.0P—0.5Si | Mixed-velocity spraying method | 4.0 | 0.8 | 5.0 | 24.8 | −0.349 | 927 | 12.3 |
| 171 | Example | | Mixed-velocity spraying method | 5.0 | 1.0 | 5.0 | 25.0 | −0.104 | 886 | 16.2 |
| 172 | Comparative | | Conventional method | 5.0 | 1.0 | 5.0 | 24.9 | −0.002 | 1057 | — |
| | example | | | | | | | | | |
| 173 | Example | | Mixed-velocity spraying method | 10.0 | 2.0 | 5.0 | 25.0 | 0.104 | 878 | 16.9 |
| 174 | Example | | Mixed-velocity spraying method | 10.5 | 2.1 | 5.0 | 24.9 | 0.350 | 927 | 12.3 |
| 175 | Example | 62.2Fe—20.8Co—11.5B—5.0P—0.5Si | Mixed-velocity spraying method | 4.0 | 0.8 | 5.0 | 25.2 | −0.347 | 915 | 12.4 |
| 176 | Example | | Mixed-velocity spraying method | 5.0 | 1.0 | 5.0 | 24.8 | −0.106 | 875 | 16.3 |
| 177 | Comparative | | Conventional method | 5.0 | 1.0 | 5.0 | 25.0 | −0.001 | 1045 | — |
| | example | | | | | | | | | |
| 178 | Example | | Mixed-velocity spraying method | 10.0 | 2.0 | 5.0 | 25.0 | 0.109 | 865 | 17.2 |
| 179 | Example | | Mixed-velocity spraying method | 10.5 | 2.1 | 5.0 | 24.8 | 0.346 | 913 | 12.6 |
| 180 | Example | 62.2Fe—20.8Co—9.5B—7.0P—0.5Si | Mixed-velocity spraying method | 4.0 | 0.8 | 5.0 | 24.9 | −0.353 | 909 | 12.3 |
| 181 | Example | | Mixed-velocity spraying method | 5.0 | 1.0 | 5.0 | 25.1 | −0.108 | 860 | 17.1 |
| 182 | Comparative | | Conventional method | 5.0 | 1.0 | 5.0 | 25.2 | −0.002 | 1037 | — |
| | example | | | | | | | | | |
| 183 | Example | | Mixed-velocity spraying method | 10.0 | 2.0 | 5.0 | 24.9 | 0.107 | 864 | 16.7 |
| 184 | Example | | Mixed-velocity spraying method | 10.5 | 2.1 | 5.0 | 25.2 | 0.353 | 906 | 12.6 |
| 185 | Example | 58.8Fe—25.2Co—4.0B—10.0P—2.0Si | Mixed-velocity spraying method | 4.0 | 0.8 | 5.0 | 25.0 | −0.347 | 781 | 12.3 |
| 186 | Example | | Mixed-velocity spraying method | 5.0 | 1.0 | 5.0 | 25.0 | −0.106 | 740 | 16.9 |
| 187 | Comparative | | Conventional method | 5.0 | 1.0 | 5.0 | 24.8 | −0.003 | 891 | — |
| | example | | | | | | | | | |
| 188 | Example | | Mixed-velocity spraying method | 10.0 | 2.0 | 5.0 | 24.8 | 0.104 | 742 | 16.7 |
| 189 | Example | | Mixed-velocity spraying method | 10.5 | 2.1 | 5.0 | 24.9 | 0.351 | 780 | 12.5 |
| 190 | Example | 58.8Fe—25.2Co—4.0B—8.0P—4.0Si | Mixed-velocity spraying method | 4.0 | 0.8 | 5.0 | 25.0 | −0.346 | 874 | 12.7 |
| 191 | Example | | Mixed-velocity spraying method | 5.0 | 1.0 | 5.0 | 25.2 | −0.109 | 841 | 16.0 |
| 192 | Comparative | | Conventional method | 5.0 | 1.0 | 5.0 | 25.2 | 0.001 | 1001 | — |
| | example | | | | | | | | | |
| 193 | Example | | Mixed-velocity spraying method | 10.0 | 2.0 | 5.0 | 24.9 | 0.103 | 829 | 17.2 |
| 194 | Example | | Mixed-velocity spraying method | 10.5 | 2.1 | 5.0 | 24.9 | 0.347 | 876 | 12.5 |
| 195 | Example | 58.8Fe—25.2Co—4.0B—6.0P—6.0Si | Mixed-velocity spraying method | 4.0 | 0.8 | 5.0 | 25.0 | −0.349 | 901 | 12.7 |
| 196 | Example | | Mixed-velocity spraying method | 5.0 | 1.0 | 5.0 | 24.8 | −0.106 | 861 | 16.6 |
| 197 | Comparative | | Conventional method | 5.0 | 1.0 | 5.0 | 25.2 | −0.003 | 1032 | — |
| | example | | | | | | | | | |
| 198 | Example | | Mixed-velocity spraying method | 10.0 | 2.0 | 5.0 | 25.2 | 0.104 | 854 | 17.2 |
| 199 | Example | | Mixed-velocity spraying method | 10.5 | 2.1 | 5.0 | 25.1 | 0.353 | 901 | 12.7 |
| 200 | Example | 58.8Fe—25.2Co—4.0B—4.0P—8.0Si | Mixed-velocity spraying method | 4.0 | 0.8 | 5.0 | 25.0 | −0.349 | 898 | 12.3 |
| 201 | Example | | Mixed-velocity spraying method | 5.0 | 1.0 | 5.0 | 25.0 | −0.104 | 849 | 17.1 |
| 202 | Comparative | | Conventional method | 5.0 | 1.0 | 5.0 | 25.0 | −0.003 | 1024 | — |
| | example | | | | | | | | | |
| 203 | Example | | Mixed-velocity spraying method | 10.0 | 2.0 | 5.0 | 24.8 | 0.105 | 855 | 16.5 |
| 204 | Example | | Mixed-velocity spraying method | 10.5 | 2.1 | 5.0 | 24.8 | 0.349 | 893 | 12.8 |
| 205 | Example | 58.8Fe—25.2Co—4.0B—2.0P—10.0Si | Mixed-velocity spraying method | 4.0 | 0.8 | 5.0 | 25.0 | −0.347 | 875 | 12.3 |
| 206 | Example | | Mixed-velocity spraying method | 5.0 | 1.0 | 5.0 | 24.9 | −0.108 | 828 | 17.0 |
| 207 | Comparative | | Conventional method | 5.0 | 1.0 | 5.0 | 24.8 | 0.001 | 998 | — |
| | example | | | | | | | | | |
| 208 | Example | | Mixed-velocity spraying method | 10.0 | 2.0 | 5.0 | 25.1 | 0.104 | 836 | 16.2 |
| 209 | Example | | Mixed-velocity spraying method | 10.5 | 2.1 | 5.0 | 25.0 | 0.350 | 874 | 12.4 |
| 210 | Example | 62.7Fe—20.8Co—14.0B—1.5P—0.5Si—0.5C | Mixed-velocity spraying method | 4.0 | 0.8 | 5.0 | 25.0 | −0.352 | 869 | 12.4 |
| 211 | Example | | Mixed-velocity spraying method | 5.0 | 1.0 | 5.0 | 25.0 | −0.101 | 830 | 16.3 |
| 212 | Comparative | | Conventional method | 5.0 | 1.0 | 5.0 | 24.9 | 0.002 | 992 | — |
| | example | | | | | | | | | |
| 213 | Example | | Mixed-velocity spraying method | 10.0 | 2.0 | 5.0 | 25.0 | 0.105 | 824 | 16.9 |
| 214 | Example | | Mixed-velocity spraying method | 10.5 | 2.1 | 5.0 | 24.9 | 0.353 | 868 | 12.5 |
| 215 | Example | 62.7Fe—20.8Co—13.5B—1.5P—0.5Si—1.0C | Mixed-velocity spraying method | 4.0 | 0.8 | 5.0 | 25.2 | −0.354 | 896 | 12.5 |
| 216 | Example | | Mixed-velocity spraying method | 5.0 | 1.0 | 5.0 | 24.8 | −0.107 | 850 | 17.0 |
| 217 | Comparative | | Conventional method | 5.0 | 1.0 | 5.0 | 25.0 | −0.001 | 1024 | — |
| | example | | | | | | | | | |
| 218 | Example | | Mixed-velocity spraying method | 10.0 | 2.0 | 5.0 | 25.0 | 0.107 | 848 | 17.2 |
| 219 | Example | | Mixed-velocity spraying method | 10.5 | 2.1 | 5.0 | 24.8 | 0.347 | 894 | 12.7 |

TABLE 3D

| | | | | | | | | | Core loss | |
|---|---|---|---|---|---|---|---|---|---|---|
| | Example/ | | | | Molten | Gas pressure/ | Powder A | | Measured | Improved |
| | Comparative | Powder A composition | | Gas pressure | amount | molten amount | Median size | Powder A | value | rate |
| Sample No. | example | (at %) | Atomizer | (MPa) | (kg/min) | (MPa · min/kg) | (μm) | “my” | (kW/m3) | (%) |
| 220 | Example | 62.7Fe—20.8Co—11.5B—1.5P—0.5Si—3.0C | Mixed-velocity spraying method | 4.0 | 0.8 | 5.0 | 24.9 | −0.349 | 907 | 12.5 |
| 221 | Example | | Mixed-velocity spraying method | 5.0 | 1.0 | 5.0 | 25.1 | −0.103 | 859 | 17.2 |
| 222 | Comparative | | Conventional method | 5.0 | 1.0 | 5.0 | 25.2 | −0.003 | 1037 | — |
| | example | | | | | | | | | |
| 223 | Example | | Mixed-velocity spraying method | 10.0 | 2.0 | 5.0 | 24.9 | 0.101 | 871 | 16.0 |
| 224 | Example | | Mixed-velocity spraying method | 10.5 | 2.1 | 5.0 | 25.2 | 0.347 | 906 | 12.6 |
| 225 | Example | 63.0Fe—21.0Co—12.5B—2.0P—0.5Si—0.5C—0.5Cr | Mixed-velocity spraying method | 4.0 | 0.8 | 5.0 | 25.2 | −0.347 | 931 | 12.7 |
| 226 | Example | | Mixed-velocity spraying method | 5.0 | 1.0 | 5.0 | 24.8 | −0.101 | 894 | 16.1 |
| 227 | Comparative | | Conventional method | 5.0 | 1.0 | 5.0 | 25.0 | 0.001 | 1066 | — |
| | example | | | | | | | | | |
| 228 | Example | | Mixed-velocity spraying method | 10.0 | 2.0 | 5.0 | 25.0 | 0.106 | 892 | 16.3 |
| 229 | Example | | Mixed-velocity spraying method | 10.5 | 2.1 | 5.0 | 24.8 | 0.347 | 934 | 12.4 |
| 230 | Example | 63.0Fe—21.0Co—10.5B—4.0P—0.5Si—0.5C—0.5Cr | Mixed-velocity spraying method | 4.0 | 0.8 | 5.0 | 24.9 | −0.350 | 947 | 12.5 |
| 231 | Example | | Mixed-velocity spraying method | 5.0 | 1.0 | 5.0 | 25.1 | −0.106 | 898 | 17.0 |
| 232 | Comparative | | Conventional method | 5.0 | 1.0 | 5.0 | 25.2 | −0.001 | 1082 | — |
| | example | | | | | | | | | |
| 233 | Example | | Mixed-velocity spraying method | 10.0 | 2.0 | 5.0 | 24.9 | 0.109 | 896 | 17.2 |
| 234 | Example | | Mixed-velocity spraying method | 10.5 | 2.1 | 5.0 | 25.2 | 0.347 | 945 | 12.7 |
| 235 | Example | 73.0Fe—10.5B—11.5Si—3.0C—2.0Cr | Mixed-velocity spraying method | 4.0 | 0.8 | 5.0 | 25.1 | −0.346 | 862 | 13.9 |
| 236 | Example | | Mixed-velocity spraying method | 5.0 | 1.0 | 5.0 | 24.9 | −0.108 | 838 | 16.3 |
| 237 | Comparative | | Conventional method | 5.0 | 1.0 | 5.0 | 25.1 | −0.002 | 1001 | — |
| | example | | | | | | | | | |
| 238 | Example | | Mixed-velocity spraying method | 10.0 | 2.0 | 5.0 | 25.0 | 0.103 | 831 | 17.0 |
| 239 | Example | | Mixed-velocity spraying method | 10.5 | 2.1 | 5.0 | 24.9 | 0.349 | 879 | 12.2 |
| 240 | Example | 79.0Fe—13.0B—6.0Si—2.0C | Mixed-velocity spraying method | 4.0 | 0.8 | 5.0 | 25.0 | −0.351 | 883 | 13.1 |
| 241 | Example | | Mixed-velocity spraying method | 5.0 | 1.0 | 5.0 | 25.1 | −0.109 | 840 | 17.3 |
| 242 | Comparative | | Conventional method | 5.0 | 1.0 | 5.0 | 24.9 | −0.002 | 1016 | — |
| | example | | | | | | | | | |
| 243 | Example | | Mixed-velocity spraying method | 10.0 | 2.0 | 5.0 | 25.1 | 0.104 | 852 | 16.1 |
| 244 | Example | | Mixed-velocity spraying method | 10.5 | 2.1 | 5.0 | 25.2 | 0.354 | 878 | 13.6 |
| 245 | Example | 75.0Fe—15.0B—10.0Si | Mixed-velocity spraying method | 4.0 | 0.8 | 5.0 | 24.9 | −0.350 | 890 | 12.8 |
| 246 | Example | | Mixed-velocity spraying method | 5.0 | 1.0 | 5.0 | 24.9 | −0.108 | 844 | 17.3 |
| 247 | Comparative | | Conventional method | 5.0 | 1.0 | 5.0 | 24.8 | 0.001 | 1021 | — |
| | example | | | | | | | | | |
| 248 | Example | | Mixed-velocity spraying method | 10.0 | 2.0 | 5.0 | 24.9 | 0.107 | 844 | 17.3 |
| 249 | Example | | Mixed-velocity spraying method | 10.5 | 2.1 | 5.0 | 25.2 | 0.348 | 892 | 12.6 |
| 250 | Example | 64.8Co—7.2Fe—2.0Nb—18.0B—7.0Si—1.0P | Mixed-velocity spraying method | 4.0 | 0.8 | 5.0 | 24.9 | −0.346 | 815 | 12.5 |
| 251 | Example | | Mixed-velocity spraying method | 5.0 | 1.0 | 5.0 | 25.1 | −0.102 | 775 | 16.8 |
| 252 | Comparative | | Conventional method | 5.0 | 1.0 | 5.0 | 25.2 | 0.002 | 931 | — |
| | example | | | | | | | | | |
| 253 | Example | | Mixed-velocity spraying method | 10.0 | 2.0 | 5.0 | 25.2 | 0.102 | 772 | 17.1 |
| 254 | Example | | Mixed-velocity spraying method | 10.5 | 2.1 | 5.0 | 25.2 | 0.348 | 817 | 12.2 |
| 255 | Example | 72.0Co—2.0Nb—20.0B—5.0Si—1.0P | Mixed-velocity spraying method | 4.0 | 0.8 | 5.0 | 25.2 | −0.346 | 853 | 13.1 |
| 256 | Example | | Mixed-velocity spraying method | 5.0 | 1.0 | 5.0 | 24.9 | −0.107 | 812 | 17.3 |
| 257 | Comparative | | Conventional method | 5.0 | 1.0 | 5.0 | 24.8 | −0.001 | 982 | — |
| | example | | | | | | | | | |
| 258 | Example | | Mixed-velocity spraying method | 10.0 | 2.0 | 5.0 | 25.0 | 0.101 | 814 | 17.1 |
| 259 | Example | | Mixed-velocity spraying method | 10.5 | 2.1 | 5.0 | 24.8 | 0.350 | 849 | 13.5 |

TABLE 3E

| | | | | | | | | | Core loss | |
|---|---|---|---|---|---|---|---|---|---|---|
| | Example/ | | | | Molten | Gas pressure/ | Powder A | | Measured | |
| | Comparative | Powder A composition | | Gas pressure | amount | molten amount | Median size | Powder A | value | Improved |
| Sample No. | example | (at %) | Atomizer | (MPa) | (kg/min) | (MPa · min/kg) | (μm) | “my” | (kW/m3) | rate (%) |
| 260 | Example | 73.5Fe—13.5Si—9.0B—3.0Nb—1.0Cu | Mixed-velocity spraying method | 4.0 | 0.8 | 5.0 | 25.1 | −0.352 | 532 | 13.0 |
| 261 | Example | | Mixed-velocity spraying method | 5.0 | 1.0 | 5.0 | 24.8 | −0.102 | 511 | 16.5 |
| 262 | Comparative | | Conventional method | 5.0 | 1.0 | 5.0 | 24.8 | 0.001 | 612 | — |
| | example | | | | | | | | | |
| 263 | Example | | Mixed-velocity spraying method | 10.0 | 2.0 | 5.0 | 24.9 | 0.109 | 512 | 16.3 |
| 264 | Example | | Mixed-velocity spraying method | 10.5 | 2.1 | 5.0 | 25.2 | 0.349 | 531 | 13.3 |
| 265 | Example | 82.0Fe—11.0B—5.0P—1.0Si—1.0Cu | Mixed-velocity spraying method | 4.0 | 0.8 | 5.0 | 25.1 | −0.346 | 525 | 13.7 |
| 266 | Example | | Mixed-velocity spraying method | 5.0 | 1.0 | 5.0 | 24.8 | −0.108 | 505 | 17.0 |
| 267 | Comparative | | Conventional method | 5.0 | 1.0 | 5.0 | 25.0 | 0.002 | 608 | — |
| | example | | | | | | | | | |
| 268 | Example | | Mixed-velocity spraying method | 10.0 | 2.0 | 5.0 | 24.9 | 0.102 | 506 | 16.7 |
| 269 | Example | | Mixed-velocity spraying method | 10.5 | 2.1 | 5.0 | 24.9 | 0.354 | 529 | 13.0 |
| 270 | Example | 78.0Fe—9.0B—3.0P—2.0Si—6.0Nb—1.0Cr | Mixed-velocity spraying method | 4.0 | 0.8 | 5.0 | 25.2 | −0.346 | 609 | 12.7 |
| 271 | Example | | Mixed-velocity spraying method | 5.0 | 1.0 | 5.0 | 24.8 | −0.108 | 583 | 16.5 |
| 272 | Comparative | | Conventional method | 5.0 | 1.0 | 5.0 | 25.1 | 0.003 | 698 | — |
| | example | | | | | | | | | |
| 273 | Example | | Mixed-velocity spraying method | 10.0 | 2.0 | 5.0 | 24.8 | 0.108 | 586 | 16.1 |
| 274 | Example | | Mixed-velocity spraying method | 10.5 | 2.1 | 5.0 | 25.1 | 0.349 | 607 | 13.0 |
| 275 | Example | 72.0Fe—8.0Co—11.0B—4.0P—5.0Si | Mixed-velocity spraying method | 4.0 | 0.8 | 5.0 | 25.0 | −0.346 | 625 | 13.5 |
| 276 | Example | | Mixed-velocity spraying method | 5.0 | 1.0 | 5.0 | 25.0 | −0.102 | 607 | 16.0 |
| 277 | Comparative | | Conventional method | 5.0 | 1.0 | 5.0 | 25.2 | −0.002 | 723 | — |
| | example | | | | | | | | | |
| 278 | Example | | Mixed-velocity spraying method | 10.0 | 2.0 | 5.0 | 25.1 | 0.109 | 606 | 16.2 |
| 279 | Example | | Mixed-velocity spraying method | 10.5 | 2.1 | 5.0 | 24.8 | 0.350 | 629 | 13.0 |
| 280 | Example | 62.4Fe—15.6Co—11.3B—5.0P—5.0Si—0.7Cu | Mixed-velocity spraying method | 4.0 | 0.8 | 5.0 | 25.0 | −0.348 | 649 | 12.6 |
| 281 | Example | | Mixed-velocity spraying method | 5.0 | 1.0 | 5.0 | 24.9 | −0.106 | 623 | 16.1 |
| 282 | Comparative | | Conventional method | 5.0 | 1.0 | 5.0 | 24.9 | 0.001 | 743 | — |
| | example | | | | | | | | | |
| 283 | Example | | Mixed-velocity spraying method | 10.0 | 2.0 | 5.0 | 24.9 | 0.101 | 618 | 16.8 |
| 284 | Example | | Mixed-velocity spraying method | 10.5 | 2.1 | 5.0 | 25.2 | 0.349 | 649 | 12.7 |
| 285 | Example | 55.3Fe—23.7Co—11.0B—2.0P—3.0Si—5.0Nb | Mixed-velocity spraying method | 4.0 | 0.8 | 5.0 | 24.9 | −0.348 | 633 | 13.5 |
| 286 | Example | | Mixed-velocity spraying method | 5.0 | 1.0 | 5.0 | 25.1 | −0.105 | 614 | 16.1 |
| 287 | Comparative | | Conventional method | 5.0 | 1.0 | 5.0 | 24.9 | 0.000 | 732 | — |
| | example | | | | | | | | | |
| 288 | Example | | Mixed-velocity spraying method | 10.0 | 2.0 | 5.0 | 24.9 | 0.103 | 614 | 16.1 |
| 289 | Example | | Mixed-velocity spraying method | 10.5 | 2.1 | 5.0 | 25.0 | 0.347 | 637 | 13.0 |
| 290 | Example | 100.0Fe | Mixed-velocity spraying method | 4.0 | 0.8 | 5.0 | 25.2 | −0.347 | 1695 | 13.2 |
| 291 | Example | | Mixed-velocity spraying method | 5.0 | 1.0 | 5.0 | 25.2 | −0.106 | 1633 | 16.4 |
| 292 | Comparative | | Conventional method | 5.0 | 1.0 | 5.0 | 25.0 | 0.003 | 1953 | — |
| | example | | | | | | | | | |
| 293 | Example | | Mixed-velocity spraying method | 10.0 | 2.0 | 5.0 | 24.8 | 0.109 | 1646 | 15.7 |
| 294 | Example | | Mixed-velocity spraying method | 10.5 | 2.1 | 5.0 | 25.0 | 0.351 | 1701 | 12.9 |
| 295 | Example | 100.0Co | Mixed-velocity spraying method | 4.0 | 0.8 | 5.0 | 25.1 | −0.349 | 1685 | 13.7 |
| 296 | Example | | Mixed-velocity spraying method | 5.0 | 1.0 | 5.0 | 25.1 | −0.109 | 1641 | 16.0 |
| 297 | Comparative | | Conventional method | 5.0 | 1.0 | 5.0 | 25.2 | −0.002 | 1953 | — |
| | example | | | | | | | | | |
| 298 | Example | | Mixed-velocity spraying method | 10.0 | 2.0 | 5.0 | 24.9 | 0.101 | 1646 | 15.7 |
| 299 | Example | | Mixed-velocity spraying method | 10.5 | 2.1 | 5.0 | 24.8 | 0.348 | 1687 | 13.6 |
| 300 | Example | 50.0Fe—50.0Co | Mixed-velocity spraying method | 4.0 | 0.8 | 5.0 | 24.9 | −0.349 | 1742 | 13.4 |
| 301 | Example | | Mixed-velocity spraying method | 5.0 | 1.0 | 5.0 | 25.0 | −0.103 | 1678 | 16.6 |
| 302 | Comparative | | Conventional method | 5.0 | 1.0 | 5.0 | 25.0 | −0.003 | 2012 | — |
| | example | | | | | | | | | |
| 303 | Example | | Mixed-velocity spraying method | 10.0 | 2.0 | 5.0 | 24.8 | 0.104 | 1670 | 17.0 |
| 304 | Example | | Mixed-velocity spraying method | 10.5 | 2.1 | 5.0 | 25.1 | 0.351 | 1752 | 12.9 |

TABLE 3F

| | Example/ | | | | | Gas pressure/ | Powder A | | Core loss | |
|---|---|---|---|---|---|---|---|---|---|---|
| | Comparative | Powder A composition | | Gas pressure | Molten amount | molten amount | Median size | Powder A | Measured value | Improved rate |
| Sample No. | example | (at %) | Atomizer | (MPa) | (kg/min) | (MPa · min/kg) | (μm) | “my” | (kW/m3) | (%) |
| 305 | Example | 88.0Fe—12.0Si | Mixed-velocity spraying method | 4.0 | 0.8 | 5.0 | 25.0 | −0.351 | 1581 | 13.3 |
| 306 | Example | | Mixed-velocity spraying method | 5.0 | 1.0 | 5.0 | 24.8 | −0.102 | 1533 | 15.9 |
| 307 | Comparative | | Conventional method | 5.0 | 1.0 | 5.0 | 24.8 | 0.003 | 1823 | — |
| | example | | | | | | | | | |
| 308 | Example | | Mixed-velocity spraying method | 10.0 | 2.0 | 5.0 | 24.8 | 0.102 | 1537 | 15.7 |
| 309 | Example | | Mixed-velocity spraying method | 10.5 | 2.1 | 5.0 | 24.9 | 0.349 | 1575 | 13.6 |
| 310 | Example | 50.0Fe—50.0Ni | Mixed-velocity spraying method | 4.0 | 0.8 | 5.0 | 24.9 | −0.347 | 1550 | 13.2 |
| 311 | Example | | Mixed-velocity spraying method | 5.0 | 1.0 | 5.0 | 25.0 | −0.101 | 1490 | 16.6 |
| 312 | Comparative | | Conventional method | 5.0 | 1.0 | 5.0 | 24.8 | −0.001 | 1786 | — |
| | example | | | | | | | | | |
| 313 | Example | | Mixed-velocity spraying method | 10.0 | 2.0 | 5.0 | 25.2 | 0.101 | 1491 | 16.5 |
| 314 | Example | | Mixed-velocity spraying method | 10.5 | 2.1 | 5.0 | 24.9 | 0.347 | 1561 | 12.6 |
| 315 | Example | 61.6Fe—26.4Co—12.0Si | Mixed-velocity spraying method | 4.0 | 0.8 | 5.0 | 25.2 | −0.354 | 1606 | 13.9 |
| 316 | Example | | Mixed-velocity spraying method | 5.0 | 1.0 | 5.0 | 24.9 | −0.103 | 1542 | 17.3 |
| 317 | Comparative | | Conventional method | 5.0 | 1.0 | 5.0 | 25.0 | 0.003 | 1865 | — |
| | example | | | | | | | | | |
| 318 | Example | | Mixed-velocity spraying method | 10.0 | 2.0 | 5.0 | 24.8 | 0.102 | 1567 | 16.0 |
| 319 | Example | | Mixed-velocity spraying method | 10.5 | 2.1 | 5.0 | 25.0 | 0.348 | 1636 | 12.3 |
| 320 | Example | 86.0Fe—12.0Si—2.0Cr | Mixed-velocity spraying method | 4.0 | 0.8 | 5.0 | 24.9 | −0.350 | 1634 | 12.7 |
| 321 | Example | | Mixed-velocity spraying method | 5.0 | 1.0 | 5.0 | 25.0 | −0.109 | 1569 | 16.2 |
| 322 | Comparative | | Conventional method | 5.0 | 1.0 | 5.0 | 24.9 | −0.002 | 1872 | — |
| | example | | | | | | | | | |
| 323 | Example | | Mixed-velocity spraying method | 10.0 | 2.0 | 5.0 | 24.9 | 0.101 | 1552 | 17.1 |
| 324 | Example | | Mixed-velocity spraying method | 10.5 | 2.1 | 5.0 | 25.1 | 0.350 | 1617 | 13.6 |
| 325 | Example | 77.4Fe—8.6Co—12.0Si—2.0Cr | Mixed-velocity spraying method | 4.0 | 0.8 | 5.0 | 25.0 | −0.348 | 1515 | 13.1 |
| 326 | Example | | Mixed-velocity spraying method | 5.0 | 1.0 | 5.0 | 25.0 | −0.105 | 1448 | 16.9 |
| 327 | Comparative | | Conventional method | 5.0 | 1.0 | 5.0 | 25.2 | 0.002 | 1743 | — |
| | example | | | | | | | | | |
| 328 | Example | | Mixed-velocity spraying method | 10.0 | 2.0 | 5.0 | 25.2 | 0.101 | 1447 | 17.0 |
| 329 | Example | | Mixed-velocity spraying method | 10.5 | 2.1 | 5.0 | 25.0 | 0.352 | 1506 | 13.6 |
| 330 | Example | 49.0Fe—49.0Co—2.0V | Mixed-velocity spraying method | 4.0 | 0.8 | 5.0 | 24.9 | −0.351 | 1386 | 12.2 |
| 331 | Example | | Mixed-velocity spraying method | 5.0 | 1.0 | 5.0 | 25.0 | −0.103 | 1306 | 17.3 |
| 332 | Comparative | | Conventional method | 5.0 | 1.0 | 5.0 | 25.2 | −0.002 | 1579 | — |
| | example | | | | | | | | | |
| 333 | Example | | Mixed-velocity spraying method | 10.0 | 2.0 | 5.0 | 24.9 | 0.105 | 1311 | 17.0 |
| 334 | Example | | Mixed-velocity spraying method | 10.5 | 2.1 | 5.0 | 25.2 | 0.346 | 1374 | 13.0 |
| 335 | Example | 73.7Fe—16.4Si—9.9Al | Mixed-velocity spraying method | 4.0 | 0.8 | 5.0 | 24.8 | −0.350 | 1294 | 13.8 |
| 336 | Example | | Mixed-velocity spraying method | 5.0 | 1.0 | 5.0 | 25.2 | −0.105 | 1262 | 15.9 |
| 337 | Comparative | | Conventional method | 5.0 | 1.0 | 5.0 | 24.9 | 0.001 | 1501 | — |
| | example | | | | | | | | | |
| 338 | Example | | Mixed-velocity spraying method | 10.0 | 2.0 | 5.0 | 25.1 | 0.109 | 1246 | 17.0 |
| 339 | Example | | Mixed-velocity spraying method | 10.5 | 2.1 | 5.0 | 25.2 | 0.349 | 1312 | 12.6 |
| 340 | Example | 59.0Fe—16.4Si—9.9Al—14.7Ni | Mixed-velocity spraying method | 4.0 | 0.8 | 5.0 | 25.2 | −0.354 | 1291 | 13.3 |
| 341 | Example | | Mixed-velocity spraying method | 5.0 | 1.0 | 5.0 | 25.1 | −0.102 | 1245 | 16.4 |
| 342 | Comparative | | Conventional method | 5.0 | 1.0 | 5.0 | 25.0 | 0.002 | 1489 | — |
| | example | | | | | | | | | |
| 343 | Example | | Mixed-velocity spraying method | 10.0 | 2.0 | 5.0 | 25.2 | 0.102 | 1233 | 17.2 |
| 344 | Example | | Mixed-velocity spraying method | 10.5 | 2.1 | 5.0 | 24.9 | 0.352 | 1301 | 12.6 |
| 345 | Example | 36.9Fe—36.8Co—16.4Si—9.9Al | Mixed-velocity spraying method | 4.0 | 0.8 | 5.0 | 24.9 | −0.346 | 1392 | 12.3 |
| 346 | Example | | Mixed-velocity spraying method | 5.0 | 1.0 | 5.0 | 25.0 | −0.109 | 1338 | 15.7 |
| 347 | Comparative | | Conventional method | 5.0 | 1.0 | 5.0 | 25.2 | −0.001 | 1587 | — |
| | example | | | | | | | | | |
| 348 | Example | | Mixed-velocity spraying method | 10.0 | 2.0 | 5.0 | 25.1 | 0.102 | 1336 | 15.8 |
| 349 | Example | | Mixed-velocity spraying method | 10.5 | 2.1 | 5.0 | 24.9 | 0.353 | 1392 | 12.3 |

As shown in Tables 3A to 3F, even in the case that the composition of the soft magnetic powder A was changed, the magnetic core of each Example including the soft magnetic powder A with the suitably adjusted solidity was able to improve core loss compared to the magnetic core of Comparative examples, which is similar to the case of Experiment example 1.

### Experiment Example 4

In Experiment example 4, samples of the magnetic cores of Sample Nos. 350 to 359 were formed similar to Sample Nos. 4, 6, 7, 18, and 21 shown in Table 1A and Table 1B except that the powder A and the powder B were used in a blending ratio as shown in Table 4; and, the evaluations similar to Experiment example 1 were carried out. An average solidity of the soft magnetic powder A was between 0.925 and 0.978. Results are shown in Table 4.

TABLE 4

| | | Conditions for manufacturing powder A | | | | |
|---|---|---|---|---|---|---|
| | Example/ | | Gas | Molten | Gas pressure/ | Median size |
| Sample | Comparative | | pressure | amount | molten amount | (μm) |
| No. | example | Atomizer | (MPa) | (kg/min) | (MPa · min/kg) | Powder A |
| 350 | Example | Mixed-velocity spraying method | 4.0 | 0.8 | 5.0 | 24.9 |
| 351 | Example | Mixed-velocity spraying method | 5.0 | 1 | 5.0 | 25.2 |
| 352 | Comparative | Conventional method | 5.0 | 1 | 5.0 | 25.0 |
| | example | | | | | |
| 353 | Example | Mixed-velocity spraying method | 10.0 | 2 | 5.0 | 25.0 |
| 354 | Example | Mixed-velocity spraying method | 10.5 | 2.1 | 5.0 | 24.8 |
| 4 | Example | Mixed-velocity spraying method | 4.0 | 0.8 | 5.0 | 24.9 |
| 6 | Example | Mixed-velocity spraying method | 5.0 | 1 | 5.0 | 24.9 |
| 7 | Comparative | Conventional method | 5.0 | 1 | 5.0 | 24.9 |
| | example | | | | | |
| 18 | Example | Mixed-velocity spraying method | 10.0 | 2 | 5.0 | 25.0 |
| 21 | Example | Mixed-velocity spraying method | 10.5 | 2.1 | 5.0 | 25.0 |
| 355 | Example | Mixed-velocity spraying method | 4.0 | 0.8 | 5.0 | 24.8 |
| 356 | Example | Mixed-velocity spraying method | 5.0 | 1 | 5.0 | 24.8 |
| 357 | Comparative | Conventional method | 5.0 | 1 | 5.0 | 25.1 |
| | example | | | | | |
| 358 | Example | Mixed-velocity spraying method | 10.0 | 2 | 5.0 | 24.9 |
| 359 | Example | Mixed-velocity spraying method | 10.5 | 2.1 | 5.0 | 25.1 |

| | | | | | | Core loss | |
|---|---|---|---|---|---|---|---|
| | Example/ | Median size | Core blending ratio | | | Measured | Improved |
| Sample | Comparative | (μm) | (wt %) | | Powder A | value | rate |
| No. | example | Powder B | Powder A | Powder B | “my” | (kW/m3) | (%) |
| 350 | Example | 0.8 | 50 | 50 | −0.350 | 601 | 10.3 |
| 351 | Example | 0.8 | 50 | 50 | −0.102 | 567 | 15.4 |
| 352 | Comparative | 0.8 | 50 | 50 | 0.001 | 670 | — |
| | example | | | | | | |
| 353 | Example | 0.8 | 50 | 50 | 0.105 | 565 | 15.7 |
| 354 | Example | 0.8 | 50 | 50 | 0.352 | 600 | 10.4 |
| 4 | Example | 0.8 | 70 | 30 | −0.350 | 905 | 12.7 |
| 6 | Example | 0.8 | 70 | 30 | −0.101 | 861 | 17.0 |
| 7 | Comparative | 0.8 | 70 | 30 | 0.003 | 1037 | — |
| | example | | | | | | |
| 18 | Example | 0.8 | 70 | 30 | 0.103 | 869 | 16.2 |
| 21 | Example | 0.8 | 70 | 30 | 0.347 | 908 | 12.4 |
| 355 | Example | — | 100 | 0 | −0.346 | 1177 | 16.1 |
| 356 | Example | — | 100 | 0 | −0.106 | 1117 | 20.4 |
| 357 | Comparative | — | 100 | 0 | −0.003 | 1403 | — |
| | example | | | | | | |
| 358 | Example | — | 100 | 0 | 0.104 | 1114 | 20.6 |
| 359 | Example | — | 100 | 0 | 0.353 | 1181 | 15.8 |

As shown in Table 4, even in the case that the blending ratio of the powder A and the powder B was changed, the magnetic core of each Example including the soft magnetic powder A with the suitably adjusted solidity was able to improve core loss compared to the magnetic core of Comparative examples.

### Experiment Example 5

In Experiment example 5, samples of the magnetic cores according to Sample Nos. 360 to 369 were formed similar to Sample Nos. 4, 6, 7, 18, and 21 except that the median size in terms of volume of the soft magnetic powder B was changed as shown in Table 5. The evaluations similar to Experiment example 1 were carried out. An average solidity of the soft magnetic powder A was between 0.925 and 0.978. Results are shown in Table 5.

TABLE 5

| | | Conditions for manufacturing powder A | | | | |
|---|---|---|---|---|---|---|
| | Example/ | | Gas | Molten | Gas pressure/ | Median size |
| Sample | Comparative | | pressure | amount | molten amount | (μm) |
| No. | example | Atomizer | (MPa) | (kg/min) | (MPa · min/kg) | Powder A |
| 360 | Example | Mixed-velocity spraying method | 4.0 | 0.8 | 5.0 | 25.2 |
| 361 | Example | Mixed-velocity spraying method | 5.0 | 1.0 | 5.0 | 24.9 |
| 362 | Comparative | Conventional method | 5.0 | 1.0 | 5.0 | 25.2 |
| | example | | | | | |
| 363 | Example | Mixed-velocity spraying method | 10.0 | 2.0 | 5.0 | 24.9 |
| 364 | Example | Mixed-velocity spraying method | 10.5 | 2.1 | 5.0 | 24.8 |
| 4 | Example | Mixed-velocity spraying method | 4.0 | 0.8 | 5.0 | 24.9 |
| 6 | Example | Mixed-velocity spraying method | 5.0 | 1.0 | 5.0 | 24.9 |
| 7 | Comparative | Conventional method | 5.0 | 1.0 | 5.0 | 24.9 |
| | example | | | | | |
| 18 | Example | Mixed-velocity spraying method | 10.0 | 2.0 | 5.0 | 25.0 |
| 21 | Example | Mixed-velocity spraying method | 10.5 | 2.1 | 5.0 | 25.0 |
| 365 | Example | Mixed-velocity spraying method | 4.0 | 0.8 | 5.0 | 25.2 |
| 366 | Example | Mixed-velocity spraying method | 5.0 | 1.0 | 5.0 | 25.1 |
| 367 | Comparative | Conventional method | 5.0 | 1.0 | 5.0 | 24.9 |
| | example | | | | | |
| 368 | Example | Mixed-velocity spraying method | 10.0 | 2.0 | 5.0 | 24.9 |
| 369 | Example | Mixed-velocity spraying method | 10.5 | 2.1 | 5.0 | 25.2 |

| | | | | | | Core loss | |
|---|---|---|---|---|---|---|---|
| | Example/ | Median size | Core blending ratio | | | Measured | Improved |
| Sample | Comparative | (μm) | (wt %) | | Powder A | value | rate |
| No. | example | Powder B | Powder A | Powder B | “my” | (kW/m3) | (%) |
| 360 | Example | 0.3 | 70 | 30 | −0.354 | 909 | 12.5 |
| 361 | Example | 0.3 | 70 | 30 | −0.102 | 876 | 15.7 |
| 362 | Comparative | 0.3 | 70 | 30 | −0.001 | 1039 | — |
| | example | | | | | | |
| 363 | Example | 0.3 | 70 | 30 | 0.105 | 861 | 16.9 |
| 364 | Example | 0.3 | 70 | 30 | 0.353 | 902 | 13.9 |
| 4 | Example | 0.8 | 70 | 30 | −0.350 | 905 | 12.7 |
| 6 | Example | 0.8 | 70 | 30 | −0.101 | 861 | 17.0 |
| 7 | Comparative | 0.8 | 70 | 30 | 0.003 | 1037 | — |
| | example | | | | | | |
| 18 | Example | 0.8 | 70 | 30 | 0.103 | 869 | 16.2 |
| 21 | Example | 0.8 | 70 | 30 | 0.347 | 908 | 12.4 |
| 365 | Example | 1.0 | 70 | 30 | −0.350 | 900 | 13.9 |
| 366 | Example | 1.0 | 70 | 30 | −0.103 | 879 | 15.9 |
| 367 | Comparative | 1.0 | 70 | 30 | 0.002 | 1045 | — |
| | example | | | | | | |
| 368 | Example | 1.0 | 70 | 30 | 0.104 | 874 | 16.4 |
| 369 | Example | 1.0 | 70 | 30 | 0.352 | 908 | 13.1 |

As shown in Table 5, even in the case that the particle size of the powder B was changed, the magnetic core of each Example including the soft magnetic powder A with the suitably adjusted solidity was able to improve core loss compared to the magnetic core of Comparative examples.

### Experiment Example 6

In Experiment example 6, samples of the magnetic cores of Sample Nos. 370 to 389 were formed similar to Sample Nos. 4, 6, 7, 18, and 21 of Experiment example 1 except that the composition of the soft magnetic powder B was changed as shown in Table 6. The evaluations similar to Experiment example 1 were carried out.

An average solidity of the soft magnetic powder was between 0.924 and 0.978. Results are shown in Table 6.

TABLE 6

| | | | Conditions for manufacturing powder A | | | Median size | | | Core loss | |
|---|---|---|---|---|---|---|---|---|---|---|
| | Example/ | Powder B | | Gas | Molten | (μm) | | Powder | Measured | Improved |
| Sample | Comparative | composition | | pressure | amount | Powder | Powder | A | value | rate |
| No. | example | (at %) | Atomizer | (MPa) | (kg/min) | A | B | “my” | (kW/m3) | (%) |
| 4 | Example | 100.0Fe | Mixed-velocity spraying method | 4.0 | 0.8 | 24.9 | 0.8 | −0.350 | 903 | 12.9 |
| 6 | Example | | Mixed-velocity spraying method | 5.0 | 1.0 | 24.9 | 0.8 | −0.101 | 865 | 16.6 |
| 7 | Comparative | | Conventional method | 5.0 | 1.0 | 24.9 | 0.8 | 0.003 | 1037 | — |
| | example | | | | | | | | | |
| 18 | Example | | Mixed-velocity spraying method | 10.0 | 2.0 | 25.0 | 0.8 | 0.103 | 866 | 16.5 |
| 21 | Example | | Mixed-velocity spraying method | 10.5 | 2.1 | 25.0 | 0.8 | 0.347 | 902 | 13 |
| 370 | Example | 100.0Co | Mixed-velocity spraying method | 4.0 | 0.8 | 24.9 | 0.8 | −0.348 | 885 | 13.9 |
| 371 | Example | | Mixed-velocity spraying method | 5.0 | 1.0 | 25.0 | 0.8 | −0.109 | 859 | 16.4 |
| 372 | Comparative | | Conventional method | 5.0 | 1.0 | 25.2 | 0.8 | −0.003 | 1028 | — |
| | example | | | | | | | | | |
| 373 | Example | | Mixed-velocity spraying method | 10.0 | 2.0 | 24.8 | 0.8 | 0.107 | 856 | 16.7 |
| 374 | Example | | Mixed-velocity spraying method | 10.5 | 2.1 | 25.1 | 0.8 | 0.350 | 897 | 12.7 |
| 375 | Example | 50.0Fe—50.0Co | Mixed-velocity spraying method | 4.0 | 0.8 | 25.0 | 0.8 | −0.353 | 895 | 13.4 |
| 376 | Example | | Mixed-velocity spraying method | 5.0 | 1.0 | 25.1 | 0.8 | −0.103 | 856 | 17.2 |
| 377 | Comparative | | Conventional method | 5.0 | 1.0 | 25.0 | 0.8 | −0.001 | 1034 | — |
| | example | | | | | | | | | |
| 378 | Example | | Mixed-velocity spraying method | 10.0 | 2.0 | 24.8 | 0.8 | 0.101 | 870 | 15.9 |
| 379 | Example | | Mixed-velocity spraying method | 10.5 | 2.1 | 25.1 | 0.8 | 0.349 | 907 | 12.3 |
| 380 | Example | 88.0Fe—12.0Si | Mixed-velocity spraying method | 4.0 | 0.8 | 24.9 | 0.8 | −0.353 | 919 | 12.1 |
| 381 | Example | | Mixed-velocity spraying method | 5.0 | 1.0 | 24.8 | 0.8 | −0.103 | 880 | 15.8 |
| 382 | Comparative | | Conventional method | 5.0 | 1.0 | 24.9 | 0.8 | −0.002 | 1045 | — |
| | example | | | | | | | | | |
| 383 | Example | | Mixed-velocity spraying method | 10.0 | 2.0 | 25.2 | 0.8 | 0.102 | 867 | 17.0 |
| 384 | Example | | Mixed-velocity spraying method | 10.5 | 2.1 | 25.0 | 0.8 | 0.348 | 911 | 12.8 |
| 385 | Example | 70.0Fe—30.0Ni | Mixed-velocity spraying method | 4.0 | 0.8 | 25.2 | 0.8 | −0.346 | 894 | 12.4 |
| 386 | Example | | Mixed-velocity spraying method | 5.0 | 1.0 | 25.0 | 0.8 | −0.105 | 861 | 15.7 |
| 387 | Comparative | | Conventional method | 5.0 | 1.0 | 25.0 | 0.8 | 0.000 | 1021 | — |
| | example | | | | | | | | | |
| 388 | Example | | Mixed-velocity spraying method | 10.0 | 2.0 | 24.8 | 0.8 | 0.106 | 854 | 16.4 |
| 389 | Example | | Mixed-velocity spraying method | 10.5 | 2.1 | 25.0 | 0.8 | 0.351 | 895 | 12.3 |

As shown in Table 6, even in the case that the composition of the soft magnetic powder B was changed, the magnetic core of each Example including the soft magnetic powder A with the suitably adjusted solidity was able to improve core loss compared to the magnetic core of Comparative examples.

### Experiment Example 7

In Experiment example 7, samples of the magnetic cores according to Sample Nos. 390 to 399 were formed similar to Sample Nos. 4, 6, 7, 18, and 21 except that the soft magnetic powder B and the soft magnetic powder C formed using the device of a conventional type shown in FIG. 4 and FIG. 5B were added to the soft magnetic powder A made under the same conditions as Sample Nos 4, 6, 7, 18, and 21 of Experiment example 1; and, the soft magnetic powder A, the soft magnetic powder B, and the soft magnetic powder C were blended in a blending ratio shown in Table 7. The evaluations similar to Experiment example 1 were carried out. Regarding the soft magnetic powder A, an average solidity was between 0.925 and 0.973, and an average circularity was between 0.943 and 0.967. Regarding the magnetic powder B, the composition was Fe, the median size in terms of volume was about 0.8 μm, the average solidity was between 0.970 and 0.974, and “my” was between −0.002 and 0.002. Regarding the soft magnetic powder C, the composition was Fe—Ni, the median size in terms of volume was about 3 μm, the average solidity was between 0.972 and 0.975, and “my” was between −0.003 and 0.002. Results are shown in Table 7.

TABLE 7

| | | Conditions for manufacturing powder A | | | Conditions for manufacturing powder C | | | |
|---|---|---|---|---|---|---|---|---|
| | Example/ | | Gas | Molten | | Water | Molten | Median size |
| Sample | Comparative | | pressure | amount | | pressure | amount | (μm) |
| No. | example | Atomizer | (MPa) | (kg/min) | Atomizer | (MPa) | (kg/min) | Powder A |
| 390 | Example | Mixed-velocity spraying method | 4.0 | 0.8 | Conventional method | 60 | 4.6 | 25.2 |
| 391 | Example | Mixed-velocity spraying method | 5.0 | 1 | Conventional method | 60 | 4.6 | 25.0 |
| 392 | Comparative | Conventional method | 5.0 | 1 | Conventional method | 60 | 4.6 | 25.2 |
| | example | | | | | | | |
| 393 | Example | Mixed-velocity spraying method | 10.0 | 2 | Conventional method | 60 | 4.6 | 25.0 |
| 394 | Example | Mixed-velocity spraying method | 10.5 | 2.1 | Conventional method | 60 | 4.6 | 24.9 |
| 395 | Example | Mixed-velocity spraying method | 4.0 | 0.8 | Conventional method | 60 | 4.6 | 24.8 |
| 396 | Example | Mixed-velocity spraying method | 5.0 | 1 | Conventional method | 60 | 4.6 | 25.2 |
| 397 | Comparative | Conventional method | 5.0 | 1 | Conventional method | 60 | 4.6 | 24.9 |
| | example | | | | | | | |
| 398 | Example | Mixed-velocity spraying method | 10.0 | 2 | Conventional method | 60 | 4.6 | 24.8 |
| 399 | Example | Mixed-velocity spraying method | 10.5 | 2.1 | Conventional method | 60 | 4.6 | 25.0 |
| 355 | Example | Mixed-velocity spraying method | 4.0 | 0.8 | — | — | — | 24.8 |
| 356 | Example | Mixed-velocity spraying method | 5.0 | 1 | — | — | — | 24.8 |
| 357 | Comparative | Conventional method | 5.0 | 1 | — | — | — | 25.1 |
| | example | | | | | | | |
| 358 | Example | Mixed-velocity spraying method | 10.0 | 2 | — | — | — | 24.9 |
| 359 | Example | Mixed-velocity spraying method | 10.5 | 2.1 | — | — | — | 25.1 |

| | | | | | | | | Core loss | |
|---|---|---|---|---|---|---|---|---|---|
| | Example/ | Median size | | Core blending ratio | | | | Measured | Improved |
| Sample | Comparative | (μm) | | (wt %) | | | Powder A | value | rate |
| No. | example | Powder B | Powder C | Powder A | Powder B | Powder C | “my” | (kW/m3) | (%) |
| 390 | Example | 0.8 | 3.1 | 50 | 25 | 25 | −0.347 | 610 | 10.1 |
| 391 | Example | 0.8 | 3.0 | 50 | 25 | 25 | −0.101 | 574 | 15.3 |
| 392 | Comparative | 0.8 | 2.9 | 50 | 25 | 25 | −0.003 | 678 | — |
| | example | | | | | | | | |
| 393 | Example | 0.8 | 3.0 | 50 | 25 | 25 | 0.105 | 575 | 15.2 |
| 394 | Example | 0.8 | 3.0 | 50 | 25 | 25 | 0.349 | 609 | 10.2 |
| 395 | Example | 0.8 | 2.9 | 70 | 15 | 15 | −0.351 | 865 | 13.7 |
| 396 | Example | 0.8 | 3.0 | 70 | 15 | 15 | −0.107 | 843 | 15.9 |
| 397 | Comparative | 0.8 | 3.1 | 70 | 15 | 15 | −0.001 | 1002 | — |
| | example | | | | | | | | |
| 398 | Example | 0.8 | 3.1 | 70 | 15 | 15 | 0.103 | 834 | 16.8 |
| 399 | Example | 0.8 | 3.0 | 70 | 15 | 15 | 0.353 | 876 | 12.6 |
| 355 | Example | — | — | 100 | 0 | 0 | −0.346 | 1177 | 16.1 |
| 356 | Example | — | — | 100 | 0 | 0 | −0.106 | 1117 | 20.4 |
| 357 | Comparative | — | — | 100 | 0 | 0 | −0.003 | 1403 | — |
| | example | | | | | | | | |
| 358 | Example | — | — | 100 | 0 | 0 | 0.104 | 1114 | 20.6 |
| 359 | Example | — | — | 100 | 0 | 0 | 0.353 | 1181 | 15.8 |

As shown in Table 7, even in the case that the blending ratio of the powder A, the powder B, and the powder C was changed, the magnetic core of each Example including the soft magnetic powder A with the suitably adjusted solidity was able to improve core loss compared to the magnetic core of Comparative examples.

### Experiment Example 8

In Experiment example 8, samples of the magnetic cores according to Sample Nos. 400 to 414 were formed similar to Sample Nos. 395 to 399 except that the median size in terms of volume of the soft magnetic powder C was changed as shown in Table 8. The evaluations similar to Experiment example 1 were carried out. An average solidity of the soft magnetic powder A was between 0.927 and 0.973. Results are shown in Table 8.

TABLE 8

| | | Conditions for manufacturing powder A | | | | | | | Core loss | |
|---|---|---|---|---|---|---|---|---|---|---|
| | Example/ | | Gas | Molten | Median size | | | | Measured | Improved |
| Sample | Comparative | | pressure | amount | (μm) | | | Powder A | value | rate |
| No. | example | Atomizer | (MPa) | (kg/min) | Powder A | Powder B | Powder C | “my” | (kW/m3) | (%) |
| 400 | Example | Mixed-velocity spraying method | 4.0 | 0.8 | 25.1 | 0.8 | 1.0 | −0.347 | 871 | 13.7 |
| 401 | Example | Mixed-velocity spraying method | 5.0 | 1 | 24.9 | 0.8 | 1.0 | −0.108 | 837 | 17.0 |
| 402 | Comparative | Conventional method | 5.0 | 1 | 25.1 | 0.8 | 1.0 | −0.003 | 1009 | — |
| | example | | | | | | | | | |
| 403 | Example | Mixed-velocity spraying method | 10.0 | 2 | 24.8 | 0.8 | 1.0 | 0.109 | 838 | 16.9 |
| 404 | Example | Mixed-velocity spraying method | 10.5 | 2.1 | 25.1 | 0.8 | 1.0 | 0.349 | 871 | 13.7 |
| 395 | Example | Mixed-velocity spraying method | 4.0 | 0.8 | 24.8 | 0.8 | 3.0 | −0.351 | 865 | 13.7 |
| 396 | Example | Mixed-velocity spraying method | 5.0 | 1 | 25.2 | 0.8 | 3.0 | −0.107 | 843 | 15.9 |
| 397 | Comparative | Conventional method | 5.0 | 1 | 24.9 | 0.8 | 3.0 | −0.001 | 1002 | — |
| | example | | | | | | | | | |
| 398 | Example | Mixed-velocity spraying method | 10.0 | 2 | 24.8 | 0.8 | 3.0 | 0.103 | 834 | 16.8 |
| 399 | Example | Mixed-velocity spraying method | 10.5 | 2.1 | 25.0 | 0.8 | 3.0 | 0.353 | 876 | 12.6 |
| 405 | Example | Mixed-velocity spraying method | 4.0 | 0.8 | 25.1 | 0.8 | 6.1 | −0.348 | 865 | 13.9 |
| 406 | Example | Mixed-velocity spraying method | 5.0 | 1 | 25.0 | 0.8 | 6.0 | −0.109 | 841 | 16.3 |
| 407 | Comparative | Conventional method | 5.0 | 1 | 25.1 | 0.8 | 6.1 | 0.003 | 1005 | — |
| | example | | | | | | | | | |
| 408 | Example | Mixed-velocity spraying method | 10.0 | 2 | 24.8 | 0.8 | 6.0 | 0.102 | 842 | 16.2 |
| 409 | Example | Mixed-velocity spraying method | 10.5 | 2.1 | 24.8 | 0.8 | 5.9 | 0.347 | 869 | 13.5 |
| 410 | Example | Mixed-velocity spraying method | 4.0 | 0.8 | 25.0 | 0.8 | 10.0 | −0.348 | 884 | 12.2 |
| 411 | Example | Mixed-velocity spraying method | 5.0 | 1 | 24.8 | 0.8 | 10.1 | −0.108 | 843 | 16.3 |
| 412 | Comparative | Conventional method | 5.0 | 1 | 25.2 | 0.8 | 10.0 | 0.002 | 1007 | — |
| | example | | | | | | | | | |
| 413 | Example | Mixed-velocity spraying method | 10.0 | 2 | 25.1 | 0.8 | 9.9 | 0.108 | 846 | 16.0 |
| 414 | Example | Mixed-velocity spraying method | 10.5 | 2.1 | 25.1 | 0.8 | 10.1 | 0.347 | 877 | 12.9 |

As shown in Table 8, even in the case that the particle size of the powder C was changed, the magnetic core of each Example including the soft magnetic powder A with the suitably adjusted solidity was able to improve core loss compared to the magnetic core of Comparative examples.

### Experiment Example 9

In Experiment example 9, samples of the magnetic cores according to Sample Nos. 415 to 464 were formed similar to Sample Nos. 395 to 399 of Experiment example 7 except that the composition of the soft magnetic powder C was changed as shown in Table 9A and Table 9B. The evaluations similar to Experiment example 7 were carried out. An average solidity of the soft magnetic powder A was between 0.924 and 0.973. Results are shown in Table 9A and Table 9B.

TABLE 9A

| | | | Conditions for manufacturing powder A | | |
|---|---|---|---|---|---|
| | Example/ | | | Gas | Molten |
| Sample | Comparative | Powder C composition | | pressure | amount |
| No. | example | (at %) | Atomizer | (MPa) | (kg/min) |
| 415 | Example | 70.0Fe—30.0Ni | Mixed-velocity spraying method | 4.0 | 0.8 |
| 416 | Example | | Mixed-velocity spraying method | 5.0 | 1.0 |
| 417 | Comparative | | Conventional method | 5.0 | 1.0 |
| | exaple | | | | |
| 418 | Example | | Mixed-velocity spraying method | 10.0 | 2.0 |
| 419 | Example | | Mixed-velocity spraying method | 10.5 | 2.1 |
| 420 | Example | 100.0Co | Mixed-velocity spraying method | 4.0 | 0.8 |
| 421 | Example | | Mixed-velocity spraying method | 5.0 | 1.0 |
| 422 | Comparative | | Conventional method | 5.0 | 1.0 |
| | exaple | | | | |
| 423 | Example | | Mixed-velocity spraying method | 10.0 | 2.0 |
| 424 | Example | | Mixed-velocity spraying method | 10.5 | 2.1 |
| 425 | Example | 50.0Fe—50.0Co | Mixed-velocity spraying method | 4.0 | 0.8 |
| 426 | Example | | Mixed-velocity spraying method | 5.0 | 1.0 |
| 427 | Comparative | | Conventional method | 5.0 | 1.0 |
| | exaple | | | | |
| 428 | Example | | Mixed-velocity spraying method | 10.0 | 2.0 |
| 429 | Example | | Mixed-velocity spraying method | 10.5 | 2.1 |
| 395 | Example | 88.0Fe—12.0Si | Mixed-velocity spraying method | 4.0 | 0.8 |
| 396 | Example | | Mixed-velocity spraying method | 5.0 | 1.0 |
| 397 | Comparative | | Conventional method | 5.0 | 1.0 |
| | exaple | | | | |
| 398 | Example | | Mixed-velocity spraying method | 10.0 | 2.0 |
| 399 | Example | | Mixed-velocity spraying method | 10.5 | 2.1 |
| 430 | Example | 56.0Fe—24.0Co—11.0B—6.0P—3.0Si | Mixed-velocity spraying method | 4.0 | 0.8 |
| 431 | Example | | Mixed-velocity spraying method | 5.0 | 1.0 |
| 432 | Comparative | | Conventional method | 5.0 | 1.0 |
| | exaple | | | | |
| 433 | Example | | Mixed-velocity spraying method | 10.0 | 2.0 |
| 434 | Example | | Mixed-velocity spraying method | 10.5 | 2.1 |

| | | | | | | Core loss | |
|---|---|---|---|---|---|---|---|
| | Example/ | Median size | | | | Measured | Improved |
| Sample | Comparative | (μm) | | | Powder A | value | rate |
| No. | example | Powder A | Powder B | Powder C | “my” | (kW/m3) | (%) |
| 415 | Example | 24.9 | 0.8 | 3.0 | −0.351 | 875 | 12.7 |
| 416 | Example | 25.0 | 0.8 | 3.0 | −0.107 | 830 | 17.2 |
| 417 | Comparative | 25.0 | 0.8 | 3.0 | −0.001 | 1002 | — |
| | exaple | | | | | | |
| 418 | Example | 25.1 | 0.8 | 3.0 | 0.103 | 837 | 16.5 |
| 419 | Example | 24.9 | 0.8 | 3.0 | 0.353 | 870 | 13.2 |
| 420 | Example | 24.9 | 0.8 | 3.0 | −0.350 | 910 | 12.6 |
| 421 | Example | 24.9 | 0.8 | 3.0 | −0.101 | 867 | 16.7 |
| 422 | Comparative | 24.9 | 0.8 | 3.0 | −0.001 | 1041 | — |
| | exaple | | | | | | |
| 423 | Example | 24.8 | 0.8 | 3.0 | 0.104 | 878 | 15.7 |
| 424 | Example | 25.0 | 0.8 | 3.0 | 0.351 | 896 | 13.9 |
| 425 | Example | 25.1 | 0.8 | 3.0 | −0.354 | 861 | 13.0 |
| 426 | Example | 24.8 | 0.8 | 3.0 | −0.103 | 827 | 16.5 |
| 427 | Comparative | 24.8 | 0.8 | 3.0 | 0.003 | 990 | — |
| | exaple | | | | | | |
| 428 | Example | 24.9 | 0.8 | 3.0 | 0.106 | 824 | 16.8 |
| 429 | Example | 24.8 | 0.8 | 3.0 | 0.349 | 865 | 12.6 |
| 395 | Example | 25.2 | 0.8 | 3.0 | −0.349 | 866 | 13.7 |
| 396 | Example | 25.2 | 0.8 | 3.0 | −0.103 | 832 | 17.0 |
| 397 | Comparative | 25.1 | 0.8 | 3.0 | −0.002 | 1003 | — |
| | exaple | | | | | | |
| 398 | Example | 25.2 | 0.8 | 3.0 | 0.102 | 834 | 16.8 |
| 399 | Example | 25.1 | 0.8 | 3.0 | 0.353 | 868 | 13.5 |
| 430 | Example | 25.0 | 0.8 | 3.0 | −0.350 | 851 | 13.3 |
| 431 | Example | 25.0 | 0.8 | 3.0 | −0.107 | 824 | 16.0 |
| 432 | Comparative | 25.1 | 0.8 | 3.0 | 0.003 | 981 | — |
| | exaple | | | | | | |
| 433 | Example | 25.2 | 0.8 | 3.0 | 0.106 | 823 | 16.1 |
| 434 | Example | 24.9 | 0.8 | 3.0 | 0.351 | 845 | 13.9 |

TABLE 9B

| | | | Conditions for manufacturing powder A | | | | | | | Core loss | |
|---|---|---|---|---|---|---|---|---|---|---|---|
| | Example/ | | | Gas | Molten | Median size | | | | Measured | Improved |
| Sample | Comparative | Powder C composition | | pressure | amount | (μm) | | | Powder A | value | rate |
| No. | exaple | (at %) | Atomizer | (MPa) | (kg/min) | Powder A | Powder B | Powder C | “my” | (kW/m3) | (%) |
| 435 | Example | 64.8Fe—16.2Co—11.0B—4.0P—3.0Si—1.0C | Mixed-velocity spraying method | 4.0 | 0.8 | 25.2 | 0.8 | 3.0 | −0.347 | 853 | 13.2 |
| 436 | Example | | Mixed-velocity spraying method | 5.0 | 1.0 | 25.1 | 0.8 | 3.0 | −0.109 | 816 | 17.0 |
| 437 | Comparative | | Conventional method | 5.0 | 1.0 | 24.9 | 0.8 | 3.0 | 0.001 | 983 | — |
| | exaple | | | | | | | | | | |
| 438 | Example | | Mixed-velocity spraying method | 10.0 | 2.0 | 25.2 | 0.8 | 3.0 | 0.106 | 824 | 16.2 |
| 439 | Example | | Mixed-velocity spraying method | 10.5 | 2.1 | 24.9 | 0.8 | 3.0 | 0.349 | 848 | 13.7 |
| 440 | Example | 64.8Fe—16.2Co—11.0B—3.0P—3.0Si—1.0C—1.0Cr | Mixed-velocity spraying method | 4.0 | 0.8 | 25.1 | 0.8 | 3.0 | −0.352 | 868 | 12.1 |
| 441 | Example | | Mixed-velocity spraying method | 5.0 | 1.0 | 25.2 | 0.8 | 3.0 | −0.107 | 818 | 17.1 |
| 442 | Comparative | | Conventional method | 5.0 | 1.0 | 25.0 | 0.8 | 3.0 | 0.002 | 987 | — |
| | exaple | | | | | | | | | | |
| 443 | Example | | Mixed-velocity spraying method | 10.0 | 2.0 | 24.9 | 0.8 | 3.0 | 0.105 | 818 | 17.1 |
| 444 | Example | | Mixed-velocity spraying method | 10.5 | 2.1 | 24.9 | 0.8 | 3.0 | 0.352 | 857 | 13.2 |
| 445 | Example | 73.0Fe—10.5B—11.5Si—3C—2Cr | Mixed-velocity spraying method | 4.0 | 0.8 | 25.1 | 0.8 | 3.0 | −0.346 | 872 | 12.6 |
| 446 | Example | | Mixed-velocity spraying method | 5.0 | 1.0 | 25.1 | 0.8 | 3.0 | −0.103 | 830 | 16.8 |
| 447 | Comparative | | Conventional method | 5.0 | 1.0 | 25.0 | 0.8 | 3.0 | 0.002 | 998 | — |
| | exaple | | | | | | | | | | |
| 448 | Example | | Mixed-velocity spraying method | 10.0 | 2.0 | 24.9 | 0.8 | 3.0 | 0.104 | 835 | 16.3 |
| 449 | Example | | Mixed-velocity spraying method | 10.5 | 2.1 | 24.8 | 0.8 | 3.0 | 0.352 | 874 | 12.4 |
| 450 | Example | 73.5Fe—13.5Si—9.0B—3.0Nb—1.0Cu | Mixed-velocity spraying method | 4.0 | 0.8 | 25.1 | 0.8 | 3.0 | −0.352 | 778 | 12.9 |
| 451 | Example | | Mixed-velocity spraying method | 5.0 | 1.0 | 24.9 | 0.8 | 3.0 | −0.102 | 744 | 16.7 |
| 452 | Comparative | | Conventional method | 5.0 | 1.0 | 24.9 | 0.8 | 3.0 | −0.001 | 893 | — |
| | exaple | | | | | | | | | | |
| 453 | Example | | Mixed-velocity spraying method | 10.0 | 2.0 | 25.0 | 0.8 | 3.0 | 0.101 | 744 | 16.7 |
| 454 | Example | | Mixed-velocity spraying method | 10.5 | 2.1 | 25.2 | 0.8 | 3.0 | 0.347 | 779 | 12.8 |
| 455 | Example | 82.0Fe—11.0B—5.0P—1.0Si—1.0Cu | Mixed-velocity spraying method | 4.0 | 0.8 | 24.8 | 0.8 | 3.0 | −0.350 | 776 | 12.5 |
| 456 | Example | | Mixed-velocity spraying method | 5.0 | 1.0 | 24.8 | 0.8 | 3.0 | −0.107 | 737 | 16.9 |
| 457 | Comparative | | Conventional method | 5.0 | 1.0 | 25.1 | 0.8 | 3.0 | 0.000 | 887 | — |
| | exaple | | | | | | | | | | |
| 458 | Example | | Mixed-velocity spraying method | 10.0 | 2.0 | 25.1 | 0.8 | 3.0 | 0.107 | 734 | 17.2 |
| 459 | Example | | Mixed-velocity spraying method | 10.5 | 2.1 | 24.9 | 0.8 | 3.0 | 0.351 | 774 | 12.7 |
| 460 | Example | 78.0Fe—9.0B—3.0P—2.0Si—6.0Nb—1.0Cr | Mixed-velocity spraying method | 4.0 | 0.8 | 25.1 | 0.8 | 3.0 | −0.352 | 773 | 13.3 |
| 461 | Example | | Mixed-velocity spraying method | 5.0 | 1.0 | 25.0 | 0.8 | 3.0 | −0.103 | 746 | 16.4 |
| 462 | Comparative | | Conventional method | 5.0 | 1.0 | 25.0 | 0.8 | 3.0 | 0.000 | 892 | — |
| | exaple | | | | | | | | | | |
| 463 | Example | | Mixed-velocity spraying method | 10.0 | 2.0 | 24.9 | 0.8 | 3.0 | 0.108 | 742 | 16.8 |
| 464 | Example | | Mixed-velocity spraying method | 10.5 | 2.1 | 25.2 | 0.8 | 3.0 | 0.350 | 784 | 12.1 |

As shown in Table 9A and Table 9B, even in the case that the composition of the soft magnetic powder C was changed, the magnetic core of each Example including the soft magnetic powder A with the suitably adjusted solidity was able to improve core loss compared to the magnetic core of Comparative examples, which was similar to the case of Experiment example 1.

### Experiment Example 10

In Experiment example 10, the magnetic cores according to Sample Nos. 465 to 488 were formed similar to Sample Nos. 395 to 399 of Experiment example 7 except that the conditions for manufacturing the soft magnetic powder A were changed as shown in Table 10 to adjust the solidity of the soft magnetic powder A, conditions for manufacturing the soft magnetic powder B were changed as shown in Table 10 to adjust the solidity of the soft magnetic powder B, and conditions for manufacturing the soft magnetic powder C were changed as shown in Table 10 to adjust the solidity of the soft magnetic powder C. The evaluations similar to Experiment example 7 were carried out. Regarding the soft magnetic powder A manufactured using the conventional method, an average solidity was between 0.971 and 0.975, and “my” was between −0.002 and 0.003; an average solidity of the soft magnetic powder B was between 0.968 and 0.973, and “my” was between −0.003 and 0.003; and an average solidity of the powder C was between 0.969 and 0.975, and “my” was between −0.003 and 0.003. Regarding the soft magnetic powder A manufactured using a mixed-velocity spraying method, an average solidity was between 0.924 and 0.975, and an average circularity was between 0.945 and 0.968; regarding the soft magnetic powder B, an average solidity was between 0.924 and 0.975, and an average circularity was between 0.940 and 0.961; and regarding the soft magnetic powder C, an average solidity was between 0.924 and 0.975, and an average circularity was between 0.939 and 0.964. Results are shown in Table 10.

TABLE 10

| | | Conditions for manufacturing powder A | | | Conditions for manufacturing powder B | | |
|---|---|---|---|---|---|---|---|
| | Example/ | | Gas | Molten | | Water | Molten |
| Sample | Comparative | | pressure | amount | | pressure | amount |
| No. | example | Atomizer | (MPa) | (kg/min) | Atomizer | (MPa) | (kg/min) |
| 395 | Example | Mixed-velocity spraying method | 4.0 | 0.8 | Conventional method | 60 | 4.1 |
| 396 | Example | Mixed-velocity spraying method | 5.0 | 1.0 | Conventional method | 60 | 4.1 |
| 397 | Comparative | Conventional method | 5.0 | 1.0 | Conventional method | 60 | 4.1 |
| | example | | | | | | |
| 398 | Example | Mixed-velocity spraying method | 10.0 | 2.0 | Conventional method | 60 | 4.1 |
| 399 | Example | Mixed-velocity spraying method | 10.5 | 2.1 | Conventional method | 60 | 4.1 |
| 465 | Example | Conventional method | 5.0 | 1.0 | Mixed-velocity spraying method | 50 | 3.4 |
| 466 | Example | Conventional method | 5.0 | 1.0 | Mixed-velocity spraying method | 60 | 4.1 |
| 397 | Comparative | Conventional method | 5.0 | 1.0 | Conventional method | 60 | 4.1 |
| | example | | | | | | |
| 467 | Example | Conventional method | 5.0 | 1.0 | Mixed-velocity spraying method | 80 | 5.5 |
| 468 | Example | Conventional method | 5.0 | 1.0 | Mixed-velocity spraying method | 100 | 6.9 |
| 469 | Example | Conventional method | 5.0 | 1.0 | Conventional method | 60 | 4.1 |
| 470 | Example | Conventional method | 5.0 | 1.0 | Conventional method | 60 | 4.1 |
| 397 | Comparative | Conventional method | 5.0 | 1.0 | Conventional method | 60 | 4.1 |
| | example | | | | | | |
| 471 | Example | Conventional method | 5.0 | 1.0 | Conventional method | 60 | 4.1 |
| 472 | Example | Conventional method | 5.0 | 1.0 | Conventional method | 60 | 4.1 |
| 473 | Example | Mixed-velocity spraying method | 4.0 | 0.8 | Mixed-velocity spraying method | 50 | 3.4 |
| 474 | Example | Mixed-velocity spraying method | 5.0 | 1.0 | Mixed-velocity spraying method | 60 | 4.1 |
| 397 | Comparative | Conventional method | 5.0 | 1.0 | Conventional method | 60 | 4.1 |
| | example | | | | | | |
| 475 | Example | Mixed-velocity spraying method | 10.0 | 2.0 | Mixed-velocity spraying method | 80 | 5.5 |
| 476 | Example | Mixed-velocity spraying method | 10.5 | 2.1 | Mixed-velocity spraying method | 100 | 6.9 |
| 477 | Example | Mixed-velocity spraying method | 4.0 | 0.8 | Conventional method | 60 | 4.1 |
| 478 | Example | Mixed-velocity spraying method | 5.0 | 1.0 | Conventional method | 60 | 4.1 |
| 397 | Comparative | Conventional method | 5.0 | 1.0 | Conventional method | 60 | 4.1 |
| | example | | | | | | |
| 479 | Example | Mixed-velocity spraying method | 10.0 | 2.0 | Conventional method | 60 | 4.1 |
| 480 | Example | Mixed-velocity spraying method | 10.5 | 2.1 | Conventional method | 60 | 4.1 |
| 481 | Example | Conventional method | 5.0 | 1.0 | Mixed-velocity spraying method | 50 | 3.4 |
| 482 | Example | Conventional method | 5.0 | 1.0 | Mixed-velocity spraying method | 60 | 4.1 |
| 397 | Comparative | Conventional method | 5.0 | 1.0 | Conventional method | 60 | 4.1 |
| | example | | | | | | |
| 483 | Example | Conventional method | 5.0 | 1.0 | Mixed-velocity spraying method | 80 | 5.5 |
| 484 | Example | Conventional method | 5.0 | 1.0 | Mixed-velocity spraying method | 100 | 6.9 |
| 485 | Example | Mixed-velocity spraying method | 4.0 | 0.8 | Mixed-velocity spraying method | 50 | 3.4 |
| 486 | Example | Mixed-velocity spraying method | 5.0 | 1.0 | Mixed-velocity spraying method | 60 | 4.1 |
| 397 | Comparative | Conventional method | 5.0 | 1.0 | Conventional method | 60 | 4.1 |
| | example | | | | | | |
| 487 | Example | Mixed-velocity spraying method | 10.0 | 2.0 | Mixed-velocity spraying method | 80 | 5.5 |
| 488 | Example | Mixed-velocity spraying method | 10.5 | 2.1 | Mixed-velocity spraying method | 100 | 6.9 |

| | | Conditions for manufacturing powder C | | | | | | Core loss | |
|---|---|---|---|---|---|---|---|---|---|
| | Example/ | | Water | Molten | “my” | | | Measured | Improved |
| Sample | Comparative | | pressure | amount | Powder | Powder | Powder | value | rate |
| No. | example | Atomizer | (MPa) | (kg/min) | A | B | C | (kW/m3) | (%) |
| 395 | Example | Conventional method | 60 | 4.6 | −0.351 | −0.002 | −0.003 | 865 | 13.7 |
| 396 | Example | Conventional method | 60 | 4.6 | −0.107 | 0.001 | −0.002 | 843 | 15.9 |
| 397 | Comparative | Conventional method | 60 | 1.6 | −0.001 | −0.002 | −0.002 | 1002 | — |
| | example | | | | | | | | |
| 398 | Example | Conventional method | 60 | 4.6 | 0.103 | 0.002 | 0.001 | 834 | 16.8 |
| 399 | Example | Conventional method | 60 | 4.6 | 0.353 | −0.002 | 0.001 | 876 | 12.6 |
| 465 | Example | Conventional method | 60 | 4.6 | 0.003 | −0.353 | −0.002 | 926 | 7.6 |
| 466 | Example | Conventional method | 60 | 4.6 | −0.001 | −0.106 | −0.001 | 883 | 11.9 |
| 397 | Comparative | Conventional method | 60 | 4.6 | −0.001 | −0.002 | −0.002 | 1002 | — |
| | example | | | | | | | | |
| 467 | Example | Conventional method | 60 | 4.6 | −0.003 | 0.104 | 0.000 | 881 | 12.1 |
| 468 | Example | Conventional method | 60 | 4.6 | −0.001 | 0.348 | 0.003 | 925 | 7.7 |
| 469 | Example | Mixed-velocity spraying method | 8.0 | 88 | 0.002 | 0.002 | −0.349 | 911 | 9.1 |
| 470 | Example | Mixed-velocity spraying method | 3.7 | 41 | −0.001 | 0.002 | −0.104 | 874 | 12.8 |
| 397 | Comparative | Conventional method | 60 | 4.6 | −0.001 | −0.002 | −0.002 | 1002 | — |
| | example | | | | | | | | |
| 471 | Example | Mixed-velocity spraying method | 3.0 | 32 | 0.002 | 0.002 | 0.103 | 913 | 8.9 |
| 472 | Example | Mixed-velocity spraying method | 5.6 | 60 | 0.003 | −0.001 | 0.354 | 871 | 13.1 |
| 473 | Example | Conventional method | 60 | 4.6 | −0.346 | −0.352 | −0.001 | 850 | 15.2 |
| 474 | Example | Conventional method | 60 | 4.6 | −0.108 | −0.102 | 0.003 | 823 | 17.9 |
| 397 | Comparative | Conventional method | 60 | 4.6 | −0.001 | −0.002 | −0.002 | 1002 | — |
| | example | | | | | | | | |
| 475 | Example | Conventional method | 60 | 4.6 | 0.104 | 0.108 | −0.003 | 824 | 17.8 |
| 476 | Example | Conventional method | 60 | 4.6 | 0.347 | 0.348 | 0.001 | 852 | 15.0 |
| 477 | Example | Mixed-velocity spraying method | 8.0 | 88 | −0.351 | −0.003 | −0.350 | 846 | 15.6 |
| 478 | Example | Mixed-velocity spraying method | 3.7 | 41 | −0.104 | 0.003 | −0.109 | 813 | 18.9 |
| 397 | Comparative | Conventional method | 60 | 4.6 | −0.001 | −0.002 | −0.002 | 1002 | — |
| | example | | | | | | | | |
| 479 | Example | Mixed-velocity spraying method | 3.0 | 32 | 0.104 | 0.001 | 0.109 | 811 | 19.1 |
| 480 | Example | Mixed-velocity spraying method | 5.6 | 60 | 0.346 | −0.003 | 0.351 | 846 | 15.6 |
| 481 | Example | Mixed-velocity spraying method | 8.0 | 88 | −0.001 | −0.353 | −0.348 | 906 | 9.6 |
| 482 | Example | Mixed-velocity spraying method | 3.7 | 41 | 0.003 | −0.106 | −0.105 | 864 | 13.8 |
| 397 | Comparative | Conventional method | 60 | 4.6 | −0.001 | −0.002 | −0.002 | 1002 | — |
| | example | | | | | | | | |
| 483 | Example | Mixed-velocity spraying method | 3.0 | 32 | 0.003 | 0.104 | 0.101 | 860 | 14.2 |
| 484 | Example | Mixed-velocity spraying method | 5.6 | 60 | 0.001 | 0.351 | 0.353 | 908 | 9.4 |
| 485 | Example | Mixed-velocity spraying method | 8.0 | 88 | −0.353 | −0.350 | −0.351 | 841 | 16.1 |
| 486 | Example | Mixed-velocity spraying method | 3.7 | 41 | −0.104 | −0.102 | −0.103 | 798 | 20.4 |
| 397 | Comparative | Conventional method | 60 | 1.6 | −0.001 | −0.002 | −0.002 | 1002 | — |
| | example | | | | | | | | |
| 487 | Example | Mixed-velocity spraying method | 3.0 | 32 | 0.108 | 0.105 | 0.105 | 798 | 20.4 |
| 488 | Example | Mixed-velocity spraying method | 5.6 | 60 | 0.352 | 0.354 | 0.351 | 844 | 15.8 |

As shown in Table 10, the magnetic core including the soft magnetic powder A with the suitably adjusted solidity, the soft magnetic powder B with the suitably adjusted solidity, or the soft magnetic powder C with the suitably adjusted solidity was able to improve core loss compared to the magnetic core of Comparative examples. The magnetic core including two soft magnetic powders with suitably adjusted solidities exhibited further improved core loss. The magnetic core including the soft magnetic powder A, the soft magnetic powder B, and the soft magnetic powder C with suitably adjusted solidities had even more improved core loss.

### REFERENCE NUMERALS

2 . . . Coil component
4 . . . Wound wire part
5 . . . Conductor
6 . . . Magnetic core
6a . . . Soft magnetic metal particle
6b . . . Resin
20 . . . Atomizing apparatus
21 . . . Molten metal
22 . . . Heat-resistant container
23 . . . Molten metal discharge port
26 . . . Spraying nozzle
27 . . . Spray port
27a . . . First spray port
27b . . . Second spray port

What is claimed is:

1. A soft magnetic powder comprising:
soft magnetic metal particles having a particle size distribution,
wherein
among the soft magnetic alloy particles,
particles having particle sizes satisfying a number-based cumulative frequency of greater than 30% and 40% or less are grouped as a first particle group,
particles having particle sizes satisfying the number-based cumulative frequency of greater than 50% and 60% or less are grouped as a second particle group,
particles having particle sizes satisfying the number-based cumulative frequency of greater than 70% and 80% or less are grouped as a third particle group,
particles having particle sizes satisfying the number-based cumulative frequency of greater than 90% are grouped as a fourth particle group; and
an absolute value of “my” satisfies |my| of 0.005 or greater and 0.500 or less,
provided that
a virtual two-dimensional coordinate is set using the number-based cumulative frequency of the soft magnetic metal particles as a horizontal axis and a solidity of the soft magnetic metal particles as a vertical axis,
an average of the number-based cumulative frequency obtained from each of the first particle group to the fourth particle group and an average of the solidity obtained from each of the first particle group to fourth particle group are plotted on the virtual two-dimensional coordinate, and linear approximation of plotted datum is obtained using a least-squares method to obtain a slope “my” of an obtained approximated straight line.

2. The soft magnetic powder according to claim 1, wherein a median size in terms of volume of the soft magnetic metal particles is 1 μm or larger and 50 μm or smaller.

3. A magnetic core including the soft magnetic powder according to claim 1.

4. A magnetic component including the soft magnetic powder according to claim 1.

5. An electronic device including the magnetic component according to claim 4.
